(19) United States
(12) Patent Application Publication
(10) Pub. No.: US 2025/0323669 A1
(43) Pub. Date: Oct. 16, 2025

(54) ELECTRONIC DEVICE AND METHOD FOR TRANSMITTING TRANSMISSION SIGNAL IN ELECTRONIC DEVICE

(71) Applicant: Samsung Electronics Co., Ltd., Suwon-si (KR)

(72) Inventors: Dongju LEE, Suwon-si (KR); Wonjin CHOI, Suwon-si (KR); Jaeho KIM, Suwon-si (KR); Minhong DO, Suwon-si (KR); Suho JIN, Suwon-si (KR)

(21) Appl. No.: 19/175,543

(22) Filed: Apr. 10, 2025

Related U.S. Application Data
(63) Continuation of application No. PCT/KR2025/004874, filed on Apr. 10, 2025.

(30) Foreign Application Priority Data
Apr. 15, 2024 (KR) 10-2024-0049801
May 23, 2024 (KR) 10-2024-0067153

(51) Int. Cl. H04B 1/00; H04B 1/03; H04B 1/401

(52) U.S. Cl. CPC H04B 1/0078; H04B 1/03; H04B 1/401

(57) ABSTRACT

An electronic device is provided. The electronic device includes a housing configured to be movable between a first state and a second state, a first radio frequency (RF) circuit comprising a first amplifier, a second RF circuit comprising a second amplifier, memory storing one or more computer programs, and one or more processors communicatively coupled to the first RF circuit, the second RF circuit, and the memory, wherein the one or more computer programs include computer-executable instructions that, when executed by the one or more processors individually or collectively, cause the electronic device to identify a transmission mode currently set among a plurality of transmission modes, in a first transmission mode of the plurality of transmission modes, transmit first signals corresponding to first data through the first amplifier, and concurrently transmit second signals corresponding to second data through the second amplifier, wherein the first data is different from the second data, in a second transmission mode of the plurality of transmission modes, transmit the first signals through the first amplifier, and concurrently transmit the second signals through the second amplifier, wherein the first signals and the second signals correspond to same data, identify a state of the housing among the first state and the second state, based on the transmission mode currently set and the state of the housing, identify a first antenna, selected from a plurality of antennas, for transmitting the first signals, and identify a second antenna, selected from the plurality of antennas, for transmitting the second signals, and transmit the first signals through the first amplifier and the first antenna, and concurrently transmit the second signals through the second amplifier and the second antenna.

### CROSS-REFERENCE TO RELATED APPLICATION(S)

This application is a continuation application, claiming priority under 35 U.S.C. § 365(c), of an International application No. PCT/KR2025/004874, filed on Apr. 10, 2025, which is based on and claims the benefit of a Korean patent application number 10-2024-0049801, filed on Apr. 15, 2024, in the Korean Intellectual Property Office, and of a Korean patent application number 10-2024-0067153, filed on May 23, 2024, in the Korean Intellectual Property Office, the disclosure of each of which is incorporated by reference herein in its entirety.

### TECHNICAL FIELD

The disclosure relates to an electronic device and a method for transmitting a transmission signal in the electronic device.

### BACKGROUND ART

As mobile communication technology evolves, multi-functional portable terminals are commonplace and, to meet increasing demand for radio traffic, vigorous efforts are underway to develop 5th generation (5G) communication systems. To achieve a higher data transmission rate, 5G communication systems are being implemented on higher frequency bands (e.g., a band of 25 GHz to 60 GHz) as well as those used for 3rd generation (3G) communication systems and long-term evolution (LTE) communication systems.

For example, to mitigate pathloss on the millimeter wave (mm Wave) band and increase the reach of radio waves, the following techniques are taken into account for the 5G communication system: beamforming, massive multi-input multi-output (MIMO), full dimensional MIMO (FD-MIMO), array antenna, analog beamforming, and large scale antenna.

To transmit a signal from an electronic device to a communication network (e.g., a base station), data generated from a processor or a communication processor in the electronic device may be signal-processed through a radio frequency integrated circuit (RFIC) and radio frequency (RF) circuit (e.g., a radio frequency front-end (RFFE)) and then transmitted to the outside of the electronic device through at least one antenna.

The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to provide an electronic device and a method for transmitting a transmission signal in the electronic device.

Additional aspects will be set forth in part in the description which follows and, in part, will be apparent from the description, or may be learned by practice of the presented embodiments.

### Solution to Problems

In accordance with an aspect of the disclosure, an electronic device is provided. The electronic device includes a housing configured to be movable between a first state and a second state, a first radio frequency (RF) circuit comprising a first amplifier, a second RF circuit comprising a second amplifier, memory storing one or more computer programs, and one or more processors communicatively coupled to the first RF circuit, the second RF circuit, and the memory, wherein the one or computer programs include computer-executable instructions that, when executed by the one or more processors individually or collectively, cause the electronic device to identify a transmission mode currently set among a plurality of transmission modes, in a first transmission mode of the plurality of transmission modes, transmit first signals corresponding to first data through the first amplifier, and concurrently transmit second signals corresponding to second data through the second amplifier, wherein the first data is different from the second data, in a second transmission mode of the plurality of transmission modes, transmit the first signals through the first amplifier, and concurrently transmit the second signals through the second amplifier, wherein the first signals and the second signals correspond to same data, identify a state of the housing among the first state and the second state, based on the transmission mode currently set and the state of the housing, identify a first antenna, selected from a plurality of antennas, for transmitting the first signals, and identify a second antenna, selected from the plurality of antennas, for transmitting the second signals, and transmit the first signals through the first amplifier and the first antenna, and concurrently transmit the second signals through the second amplifier and the second antenna.

In accordance with another aspect of the disclosure, a method performed by an electronic device including a housing configured to be movable between a first state and a second state, a first radio frequency (RF) circuit comprising a first amplifier, a second RF circuit comprising a second amplifier, and one or more processors communicatively coupled to the first RF circuit, and the second RF circuit is provided. The method includes identifying, by the electronic device, a transmission mode currently set among a plurality of transmission modes, in a first transmission mode of the plurality of transmission modes, transmitting, by the electronic device, first signals corresponding to first data through the first amplifier, and concurrently transmitting, by the electronic device, second signals corresponding to second data through the second amplifier, wherein the first data is different from the second data, in a second transmission mode of the plurality of transmission modes, transmitting, by the electronic device, the first signals through the first amplifier, and concurrently transmitting, by the electronic device, the second signals through the second amplifier, wherein the first signals and the second signals correspond to same data, identifying, by the electronic device, a state of the housing among the first state and the second state, based on the transmission mode currently set and the state of the housing, identifying, by the electronic device, a first antenna, selected from a plurality of antennas, for transmitting the first signals, and identifying, by the electronic device, a second antenna, selected from the plurality of antennas, for transmitting the second signals, and transmitting, by the electronic device, the first signals through the first amplifier and the first antenna, and concurrently transmitting, by the electronic device, the second signals through the second amplifier and the second antenna.

In accordance with another aspect of the disclosure, one or more non-transitory computer-readable storage media storing one or more computer programs including computer-executable instructions that, when executed by one or more processors of an electronic device individually or collectively, the electronic device including a housing configured to be movable between a first state and a second state, a first radio frequency (RF) circuit comprising a first amplifier, a second RF circuit comprising a second amplifier, and the one or more processors, cause the electronic device to perform operations are provided. The operations include identifying, by the electronic device, a transmission mode currently set among a plurality of transmission modes, in a first transmission mode of the plurality of transmission modes, transmitting, by the electronic device, first signals corresponding to first data through the first amplifier, and concurrently transmitting, by the electronic device, second signals corresponding to second data through the second amplifier, wherein the first data is different from the second data, in a second transmission mode of the plurality of transmission modes, transmitting, by the electronic device, the first signals through the first amplifier, and concurrently transmitting, by the electronic device, the second signals through the second amplifier, wherein the first signals and the second signals correspond to same data, identifying, by the electronic device, a state of the housing among the first state and the second state, based on the transmission mode currently set and the state of the housing, identifying, by the electronic device, a first antenna, selected from a plurality of antennas, for transmitting the first signals, and identifying, by the electronic device, a second antenna, selected from the plurality of antennas, for transmitting the second signals, and transmitting, by the electronic device, the first signals through the first amplifier and the first antenna, and concurrently transmitting, by the electronic device, the second signals through the second amplifier and the second antenna.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2A is a block diagram illustrating an electronic device for supporting legacy network communication and 5G network communication according to an embodiment of the disclosure;

FIG. 2B is a block diagram illustrating an electronic device for supporting legacy network communication and 5G network communication according to an embodiment of the disclosure;

FIG. 2C is a block diagram illustrating an electronic device for supporting legacy network communication and 5G network communication according to an embodiment of the disclosure;

FIG. 3A is a view illustrating wireless communication systems providing a legacy communication network and/or a 5G communication network according to an embodiment of the disclosure;

FIG. 3B is a view illustrating wireless communication systems providing a legacy communication network and/or a 5G communication network according to an embodiment of the disclosure;

FIG. 3C is a view illustrating wireless communication systems providing a legacy communication network and/or a 5G communication network according to an embodiment of the disclosure;

FIG. 4A is a block diagram illustrating an electronic device according to an embodiment of the disclosure;

FIG. 4B is a block diagram illustrating an electronic device according to an embodiment of the disclosure;

FIG. 4C is a block diagram illustrating an electronic device according to an embodiment of the disclosure;

FIG. 5 is a view illustrating an antenna arrangement structure of an electronic device according to an embodiment of the disclosure;

FIG. 6 is a block diagram illustrating an electronic device according to an embodiment of the disclosure;

FIG. 7 is a block diagram illustrating an electronic device according to an embodiment of the disclosure;

FIG. 8 is a view illustrating an antenna arrangement structure of an electronic device according to an embodiment of the disclosure;

FIG. 9A is a view illustrating an outer appearance of an electronic device according to an embodiment of the disclosure;

FIG. 9B is a view illustrating an outer appearance of an electronic device according to an embodiment of the disclosure;

FIG. 10 is a block diagram illustrating an electronic device according to an embodiment of the disclosure;

FIG. 11 is a block diagram illustrating an electronic device according to an embodiment of the disclosure;

FIG. 12A is a view illustrating a transmission signal transmission path of an electronic device according to an embodiment of the disclosure;

FIG. 12B is a perspective view illustrating an electronic device according to an embodiment of the disclosure;

FIG. 13A is a block diagram illustrating an electronic device according to an embodiment of the disclosure;

FIG. 13B is a view illustrating a transmission signal transmission path of an electronic device according to an embodiment of the disclosure;

FIG. 14 is a view illustrating a transmission signal transmission path of an electronic device according to an embodiment of the disclosure;

FIG. 15A is a block diagram illustrating an electronic device according to an embodiment of the disclosure;

FIG. 15B is a view illustrating a transmission signal transmission path of an electronic device according to an embodiment of the disclosure;

FIG. 16 is a flowchart illustrating an operation method of an electronic device according to an embodiment of the disclosure;

FIG. 17 is a flowchart illustrating an operation method of an electronic device according to an embodiment of the disclosure;

FIG. 18A is a flowchart illustrating a method for operating an electronic device according to an embodiment of the disclosure;

FIG. 18B is a flowchart illustrating a method for operating an electronic device according to an embodiment of the disclosure;

FIG. 19 is a view illustrating folding state information about an electronic device according to an embodiment of the disclosure; and

FIG. 20 is a view illustrating examples of a flexible display according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi™ chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

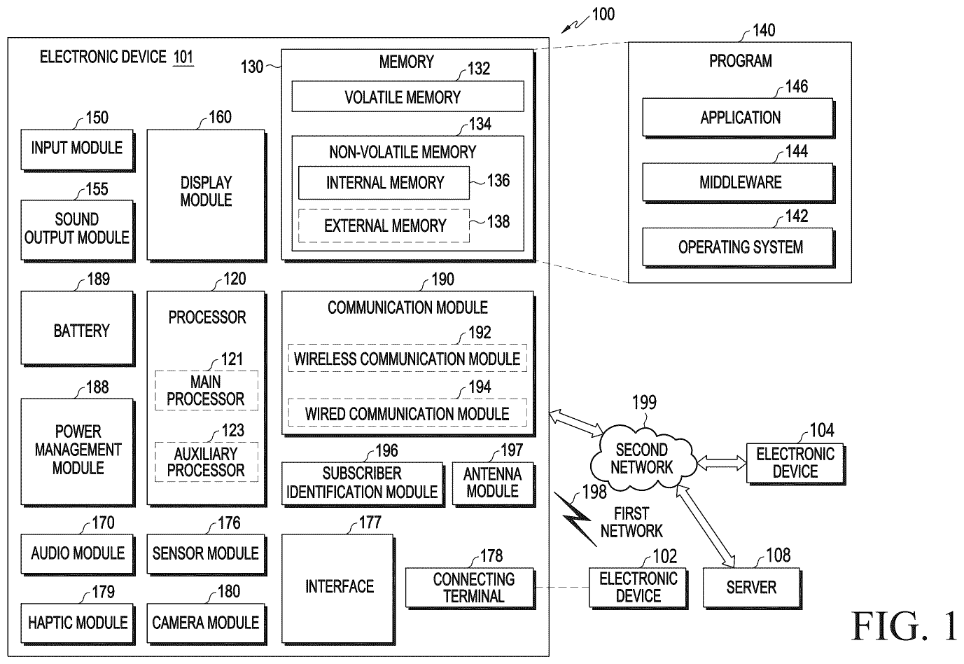

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi™) direct, or infrared data association (IrDA)) or the second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of Ims or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices (e.g., electronic devices 102 and 104 and server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

In the following description, the components easy to understand from the description of the above embodiments are denoted with or without the same reference numerals and their detailed description may be skipped. According to an embodiment of the disclosure, an electronic device may be implemented by selectively combining configurations of different embodiments, and the configuration of one embodiment may be replaced by the configuration of another embodiment. However, it is noted that the disclosure is not limited to a specific drawing or embodiment.

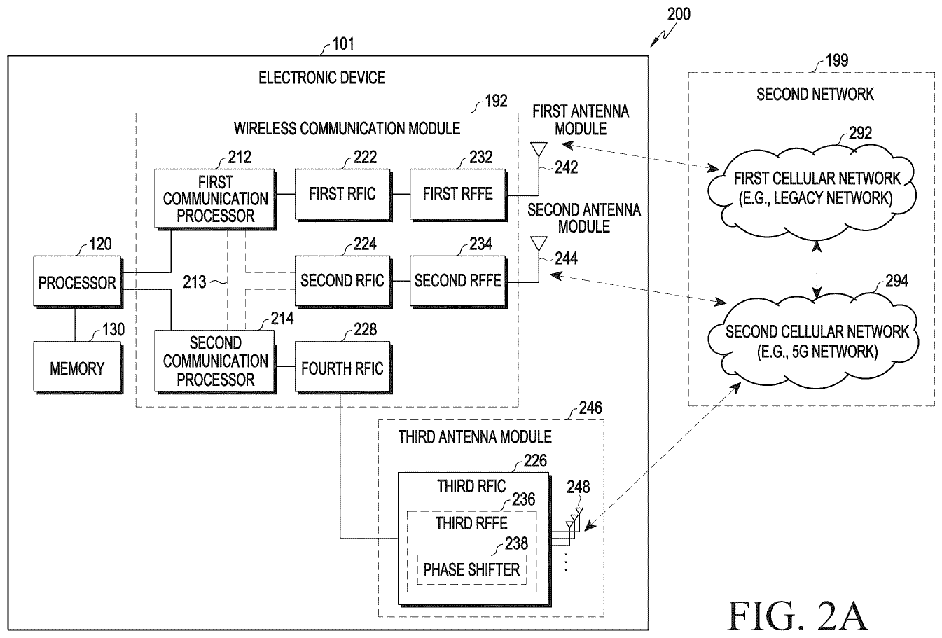

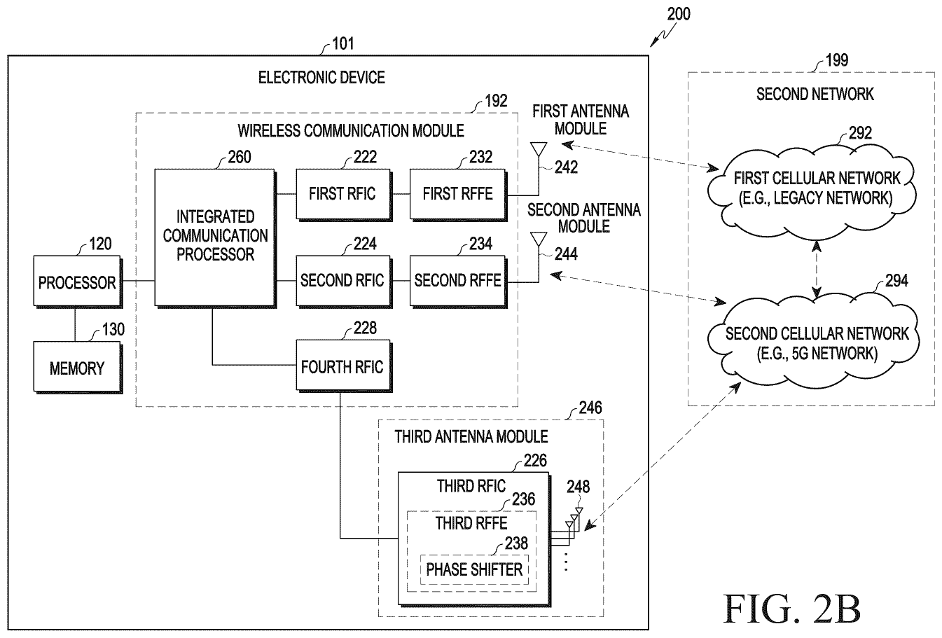

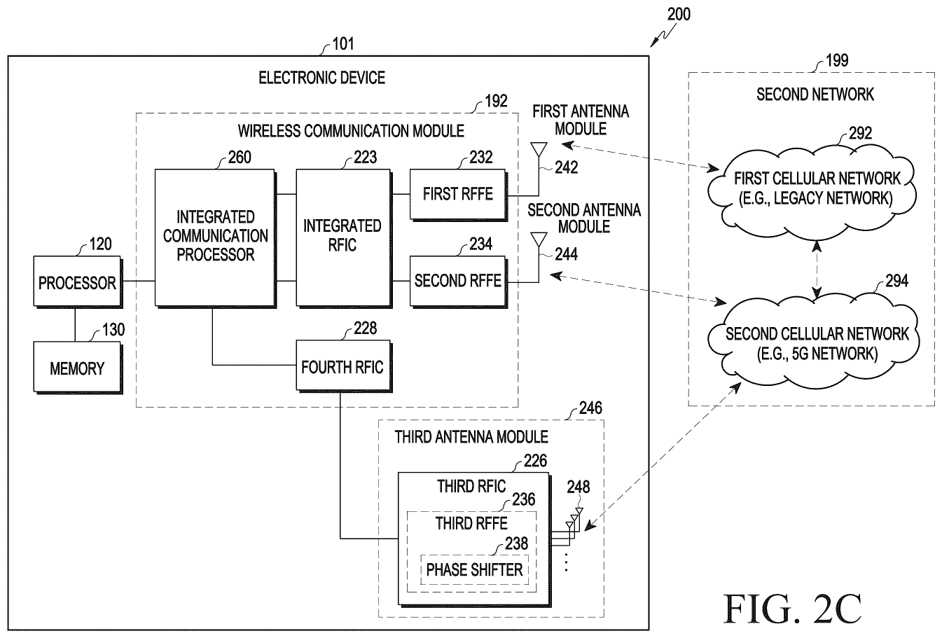

FIG. 2A is a block diagram illustrating an electronic device for supporting legacy network communication and 5G network communication according to an embodiment of the disclosure.

Referring to FIG. 2A, block diagram 200 illustrates that an electronic device 101 may include a first communication processor 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor 212, the second communication processor 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first communication processor 212 may establish a communication channel of a band that is to be used for wireless communication with the first cellular network 292 or may support legacy network communication via the established communication channel. According to various embodiments, the first cellular network may be a legacy network that includes second generation (2G), third generation (3G), fourth generation (4G), or long-term evolution (LTE) networks. The second communication processor 214 may establish a communication channel corresponding to a designated band (e.g., from about 6 GHz to about 60 GHZ) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first communication processor 212 or the second communication processor 214 may establish a communication channel corresponding to another designated band (e.g., about 6 gigahertz (GHz) or less) among the bands that are to be used for wireless communication with the second cellular network 294 or may support fifth generation (5G) network communication via the established communication channel.

The first communication processor 212 may perform data transmission/reception with the second communication processor 214. For example, data classified as transmitted via the second cellular network 294 may be changed to be transmitted via the first cellular network 292. In this case, the first communication processor 212 may receive transmission data from the second communication processor 214. For example, the first communication processor 212 may transmit/receive data to/from the second communication processor 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first communication processor 212 and the second communication processor 214 may exchange packet data information and control information using, e.g., a shared memory. The first communication processor 212 may transmit/receive various types of information, such as sensing information, information about output strength, and resource block (RB) allocation information, to/from the second communication processor 214.

According to implementation, the first communication processor 212 may not be directly connected with the second communication processor 214. In this case, the first communication processor 212 may transmit/receive data to/from the second communication processor 214 via a processor 120 (e.g., an application processor). For example, the first communication processor 212 and the second communication processor 214 may transmit/receive data to/from the processor 120 (e.g., an application processor) via an HS-UART interface or PCIe interface, but the kind of the interface is not limited thereto. The first communication processor 212 and the second communication processor 214 may exchange control information and packet data information with the processor 120 (e.g., an application processor) using a shared memory.

According to an embodiment, the first communication processor 212 and the second communication processor 214 may be implemented in a single chip or a single package. According to an embodiment, the first communication processor 212 or the second communication processor 214, along with the processor 120, an auxiliary processor 123, or communication module 190, may be formed in a single chip or single package.

FIG. 2B is a block diagram illustrating an electronic device for supporting legacy network communication and 5G network communication according to an embodiment of the disclosure.

Referring to FIG. 2B, an integrated communication processor 260 may support all of the functions for communication with the first cellular network 292 and the second cellular network 294.

Upon transmission, the first RFIC 222 may convert a baseband signal generated by the first communication processor 212 into a radio frequency (RF) signal with a frequency ranging from about 700 MHz to about 3 GHz which is used by the first cellular network 292 (e.g., a legacy network). Upon receipt, the RF signal may be obtained from the first cellular network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first communication processor 212.

Upon transmission, the second RFIC 224 may convert the baseband signal generated by the first communication processor 212 or the second communication processor 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first communication processor 212 and the second communication processor 214.

The third RFIC 226 may convert the baseband signal generated by the second communication processor 214 into a 5G Above6 band (e.g., from about 6 GHZ to about 60 GHZ) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., antennas 248) and be pre-processed via the third RFFE 236. The third RFIC 226 may convert the pre-processed 5G Above6 RF signal into a baseband signal that may be processed by the second communication processor 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second communication processor 214 into an intermediate frequency band (e.g., from about 9 GHz to about 11 GHZ) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., antennas 248) and be converted into an IF signal by the third RFIC 226. The fourth RFIC 228 may convert the IF signal into a baseband signal that may be processed by the second communication processor 214.

According to an embodiment, the first RFIC 222 and the second RFIC 224 may be implemented as at least part of a single chip or single package. According to various embodiments, when the first RFIC 222 and the second RFIC 224 in FIG. 2A or 2B are implemented as a single chip or a single package, they may be implemented as an integrated RFIC 223 as shown in FIG. 2C. In this case, the integrated RFIC 223 may be connected to the first RFFE 232 and the second RFFE 234, and the integrated RFIC 223 may convert a baseband signal into a signal of a band supported by the first RFFE 232 and/or the second RFFE 234 and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antennas 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antennas 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antennas 248 on the same substrate may shorten the length of the transmission line therebetween. This may reduce a loss (e.g., attenuation) of high-frequency band (e.g., from about 6 GHz to about 60 GHZ) signal used for 5G network communication due to the transmission line. Thus, the electronic device 101 may enhance the communication quality with the second cellular network 294 (e.g., a 5G network).

According to an embodiment, the antennas 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 130 and be accessed by other components (e.g., the processor 120, the first communication processor 212, or the second communication processor 214).

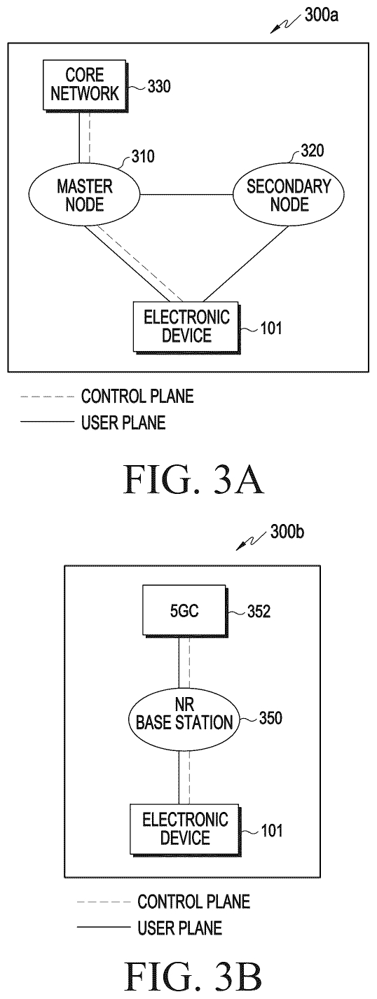

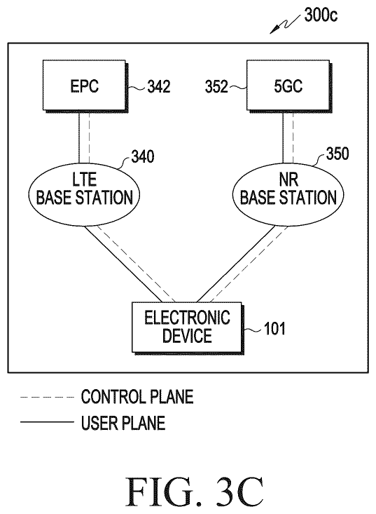

FIGS. 3A, 3B, and 3C are views illustrating wireless communication systems providing legacy communication and/or 5G communication networks according to various embodiments of the disclosure.

Referring to FIGS. 3A, 3B, and 3C, network environment 301a, network environment 300b, and network environment 300c may include at least one of a legacy network and a 5G network. The legacy network may include, e.g., a 3GPP-standard 4G or LTE base station 340 (e.g., an eNodeB (eNB)) that supports radio access with an electronic device 101 and an evolved packet core (EPC) 342 that manages 4G communication. The 5G network may include, e.g., a new radio (NR) base station 350 (e.g., a gNodeB (gNB)) that supports radio access with the electronic device 101 and a 5th generation core (5GC) 352 that manages 5G communication for the electronic device 101.

According to various embodiments, the electronic device 101 may transmit or receive control messages and user data via legacy communication and/or 5G communication. The control messages may include messages related to at least one of, e.g., security control, bearer setup, authentication, enrollment, or mobility management of the electronic device 101. The user data may mean, e.g., user data except for control messages transmitted or received between the electronic device 101 and a core network 330 (e.g., the EPC 342).

Referring to FIG. 3A, according to an embodiment, the electronic device 101 may transmit or receive at least one of a control message or user data to/from at least part (e.g., the NR base station 350 or 5GC 352) of the 5G network via at least part (e.g., the LTE base station 340 or EPC 342) of the legacy network.

According to various embodiments, a network environment 300a may include a network environment that provides wireless communication dual connectivity (DC) to the LTE base station 340 and the NR base station 350 and transmits or receives control messages to/from the electronic device 101 via one core network (e.g., core network 330) of the EPC 342 or the 5GC 352.

According various embodiments, in the DC environment, one of the LTE base station 340 or the NR base station 350 may operate as a master node (MN) 310, and the other as a secondary node (SN) 320. The MN 310 may be connected to the core network 330 to transmit and receive control messages. The MN 310 and the SN 320 may be connected with each other via a network interface to transmit or receive messages related to radio resource (e.g., communication channel) management therebetween.

According to an embodiment, the MN 310 may include the LTE base station 340, the SN 320 may include the NR base station 350, and the core network 330 may include the EPC 342. For example, control messages may be transmitted/received via the LTE base station 340 and the EPC 342, and user data may be transmitted/received via at least one of the LTE base station 340 or the NR base station 350.

According to various embodiments, the MN 310 may include the NR base station 350, the SN 320 may include the LTE base station 340, and the core network 330 may include the 5GC 352. For example, control messages may be transmitted/received via the NR base station 350 and the 5GC 352, and user data may be transmitted/received via at least one of the LTE base station 340 or the NR base station 350.

Referring to FIG. 3B, according to various embodiments, the 5G network may include the NR base station 350 and the 5GC 352 and transmit/receive control messages and user data independently from the electronic device 101.

Referring to FIG. 3C, according to an embodiment, the legacy network and the 5G network each may provide data transmission/reception independently. For example, the electronic device 101 and the EPC 342 may transmit/receive control messages and user data through the LTE base station 340. As another example, the electronic device 101 and the 5GC 352 may transmit/receive control messages and user data through the NR base station 350.

According to an embodiment, the electronic device 101 may be registered in at least one of the EPC 342 or the 5GC 352 to transmit or receive control messages.

According to an embodiment, the EPC 342 or the 5GC 352 may interwork with each other to manage communication for the electronic device 101. For example, mobility information for the electronic device 101 may be transmitted or received via the interface between the EPC 342 and the 5GC 352.

As set forth above, dual connectivity via the LTE base station 340 and the NR base station 350 may be referred to as E-UTRA new radio dual connectivity (EN-DC).

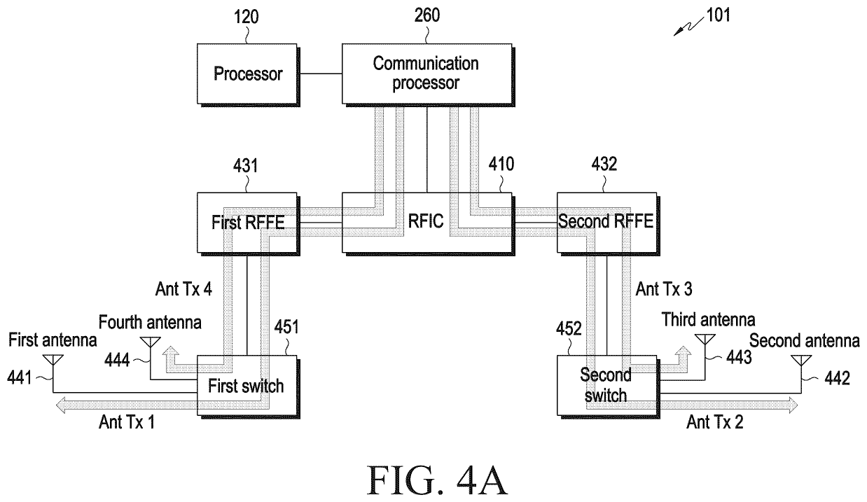

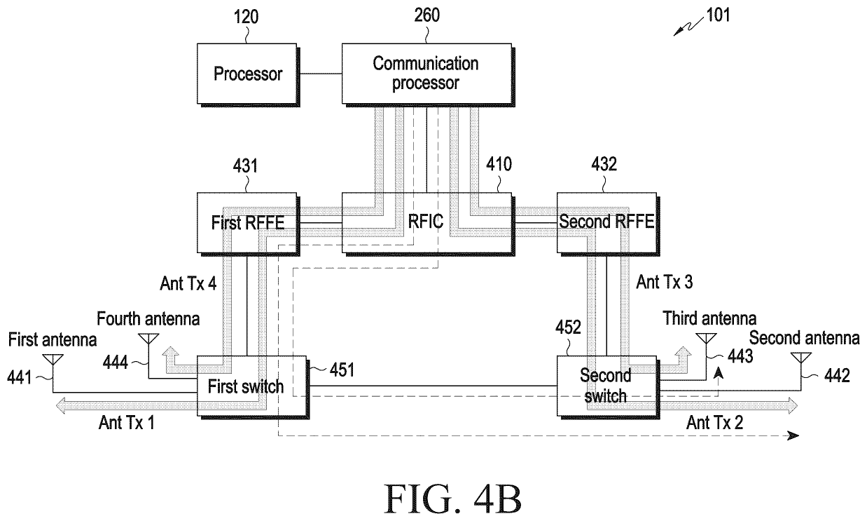

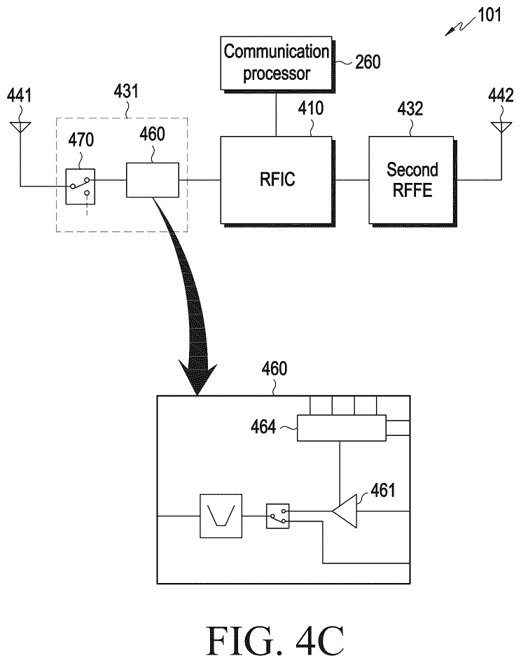

Hereinafter, a structure of an electronic device according to various embodiments is described in detail with reference to FIGS. 4A, 4B, and 4C. Although each drawing of the embodiments described below illustrates that one communication processor (e.g., communication processor 260) and one RFIC (e.g., RFIC 410) are connected to a plurality of RFFEs 431 and 432, various embodiments described below are not limited thereto. For example, in various embodiments described below, as illustrated in FIG. 2A or 2B, a plurality of communication processors 212 and 214 and/or a plurality of RFICs 222, 224, 226, and 228 may be connected to the plurality of RFFEs 431 and 432.

FIGS. 4A and 4B are block diagrams illustrating electronic devices according to various embodiments of the disclosure.

Referring to FIG. 4A, according to various embodiments, an electronic device (e.g., the electronic device 101 of FIG. 1) may include a processor 120, a communication processor 260, an RFIC 410, a first RFFE 431, a second RFFE 432, a first antenna 441, a second antenna 442, a third antenna 443, a fourth antenna 444, a first switch 451, or a second switch 452. For example, the first RFFE 431 may be disposed at an upper portion in the housing of the electronic device 101, and the second RFFE 432 may be disposed at a lower portion in the housing of the electronic device 101 than the first RFFE 431. However, various embodiments of the disclosure are not limited to the placement positions.

According to various embodiments, upon transmission, the RFIC 410 may convert a baseband signal generated by the communication processor 260 into a radio frequency (RF) signal used in the first communication network or the second communication network. For example, the RFIC 410 may transmit an RF signal used in the first communication network to the first antenna 441 or the fourth antenna 444 through the first RFFE 431 and the first switch 451. The RFIC 410 may transmit an RF signal used in the first communication network or the second communication network to the second antenna 442 or the third antenna 443 through the second RFFE 432 and the second switch 452. According to various embodiments, the RFIC 410 may transmit an RF signal corresponding to the first communication network (e.g., NR) to the first antenna 441 or the fourth antenna 444 through the first RFFE 431 and may transmit an RF signal corresponding to the second communication network (e.g., LTE) to the second antenna 442 or the third antenna 443 through the second RFFE 432. According to another embodiment, the RFIC 410 may operate as a multi-input multi-output (MIMO) antenna by transmitting an RF signal corresponding to the first communication network (e.g., NR) or the second communication network (e.g., LTE) to the first antenna 441 or the fourth antenna 444 through the first RFFE 431 and transmitting an RF signal corresponding to the same first communication network (e.g., NR) or second communication network (e.g., LTE) to the second antenna 442 or the third antenna 443 through the second RFFE 432.

According to various embodiments, the transmission path of transmission from the RFIC 410 to the first antenna 441 through the first RFFE 431 and the first switch 451 may be referred to as a ‘first antenna transmission path (Ant Tx 1)’. The transmission path of transmission from the RFIC 410 to the fourth antenna 444 through the first RFFE 431 and the first switch 451 may be referred to as a ‘fourth antenna transmission path (Ant Tx 4)’.

According to various embodiments, upon transmission, the RFIC 410 may convert a baseband signal generated by the communication processor 260 into a radio frequency (RF) signal used in the first communication network or the second communication network. For example, the RFIC 410 may transmits an RF signal used in the first communication network or the second communication network to the second antenna 442 or the third antenna 443 through the second RFFE 432 and the second switch 452.

According to various embodiments, the transmission path of transmission from the RFIC 410 to the second antenna 442 through the second RFFE 432 and the second switch 452 may be referred to as a ‘second antenna transmission path (Ant Tx 2)’. The transmission path of transmission from the RFIC 410 to the third antenna 443 through the second RFFE 432 and the second switch 452 may be referred to as a ‘third antenna transmission path (Ant Tx 3)’.

According to various embodiments, during reception, the RF signal may be received from the first communication network through the first antenna 441 or the fourth antenna 444, and the received RF signal may be transmitted to the communication processor 260 through at least one RFIC. Further, the RF signal may be received from the first communication network or the second communication network through the second antenna 442 or the third antenna 443, and the received RF signal may be transmitted to the communication processor 260 through at least one RFIC.

According to various embodiments, the first communication network and the second communication network may be communication networks different from each other. For example, the first communication network may be a 5G network, and the second communication network may be a legacy network (e.g., an LTE network). When the first communication network is a 5G network, the first RFFE 431 may be designed to be suitable for processing signals corresponding to the 5G network, and the second RFFE 432 may be designed to be suitable for processing signals corresponding to the legacy network. According to various embodiments, a frequency band of a signal transmitted through the first RFFE 431 and a frequency band of a signal transmitted through the second RFFE 432 may be the same, similar, or different.

According to various embodiments, when the electronic device transmits a signal through any one of the first antenna 441 and the fourth antenna 444 through the first RFFE 431 and the first switch 451 and transmits a reference signal through the first antenna 441 and the fourth antenna 444, it may be referred to as ‘1T2R’ because it uses one transmission antenna Tx and two reception antennas Rx. According to various embodiments, when the electronic device transmits a signal through any one of the second antenna 442 and the third antenna 443 through the second RFFE 432 and the second switch 452 and transmits a reference signal through the second antenna 442 and the third antenna 443, it may be referred to as ‘1T2R’ because it uses one transmission antenna Tx and two reception antennas Rx.

According to various embodiments, when the electronic device simultaneously transmits and receives data through the first RFFE 431 and the second RFFE 432, it may be referred to as ‘2T4R’ because it uses two transmission antennas Tx and four reception antennas Rx. Since the electronic device illustrated in FIG. 4A may operate as 1T2R or 2T4R according to various embodiments, the electronic device may be referred to as an electronic device supporting ‘1T2R/2T4R’.

Referring to FIG. 4B, an electronic device (e.g., the electronic device 101 of FIG. 1) according to various embodiments may include a processor 120, a communication processor 260, an RFIC 410, a first RFFE 431, a second RFFE 432, a first antenna 441, a second antenna 442, a third antenna 443, a fourth antenna 444, a first switch 451, or a second switch 452. For example, the first RFFE 431 may be disposed at an upper portion in the housing of the electronic device 101, and the second RFFE 432 may be disposed at a lower portion in the housing of the electronic device 101 than the first RFFE 431. However, various embodiments of the disclosure are not limited to the placement positions. In the embodiment of FIG. 4B to be described below, descriptions applicable in common to FIG. 4A described above are omitted.

According to various embodiments, upon transmission, the RFIC 410 may convert a baseband signal generated by the communication processor 260 into a radio frequency (RF) signal used in the first communication network or the second communication network. For example, the RFIC 410 may transmit an RF signal used in the first communication network to the first antenna 441 or the fourth antenna 444 through the first RFFE 431 and the first switch 451. Further, the RFIC 410 may transmit an RF signal used in the first communication network to the second antenna 442 or the third antenna 443 through the first RFFE 431, the first switch 451, and the second switch 452.

According to various embodiments, the RFIC 410 may transmit an RF signal corresponding to the first communication network (e.g., NR) to the first antenna 441 or the fourth antenna 444 through the first RFFE 431 and may transmit an RF signal corresponding to the second communication network (e.g., LTE) to the second antenna 442 or the third antenna 443 through the second RFFE 432. According to various embodiments, the RFIC 410 may operate as a multi-input multi-output (MIMO) antenna by transmitting an RF signal corresponding to the first communication network (e.g., NR) or the second communication network (e.g., LTE) to the first antenna 441 or the fourth antenna 444 through the first RFFE 431 and the first switch 451 and transmitting the RF signal to the second antenna 442 or the third antenna 443 through the first RFFE 431, the first switch 451, and the second switch 452. According to various embodiments, the transmission path of transmission from the RFIC 410 to the first antenna 441 through the first RFFE 431 and the first switch 451 may be referred to as a ‘first antenna transmission path (Ant Tx 1)’. The transmission path of transmission from the RFIC 410 to the fourth antenna 444 through the first RFFE 431 and the first switch 451 may be referred to as a ‘fourth antenna transmission path (Ant Tx 4)’. The transmission path of transmission from the RFIC 410 to the second antenna 442 through the first RFFE 431, the first switch 451, and the second switch 452 may be referred to as a ‘second antenna transmission path (Ant Tx 2)’. The transmission path of transmission from the RFIC 410 to the third antenna 443 through the first RFFE 431, the first switch 451, and the second switch 452 may be referred to as a ‘third antenna transmission path (Ant Tx 3)’.

FIG. 4C is a block diagram illustrating in detail an electronic device according to an embodiment of the disclosure.

Referring to FIG. 4C, according to various embodiments, an electronic device (e.g., the electronic device 101 of FIG. 1) may include a communication processor 260, an RFIC 410, a first RFFE 431, a first antenna 441, a second RFFE 432, and a second antenna 442.

According to various embodiments, the first RFFE 431 may further include additional components different from the second RFFE 432, for signal processing suitable for the characteristics of the 5G network or for supporting multiple bands. For example, the first RFFE 431 may include a front end module (FEM) 460 and a first single pole double throw (SPDT) switch 470.

According to various embodiments, the FEM 460 may include an amplifier (e.g., a power amplifier (PA) 461) and a PA envelope tracking (ET) integrated circuit (IC) 464. According to various embodiments, the PA ET IC 464 may be included in the FEM 460 or may be connected with the FEM 460 outside the FEM 460 as illustrated in FIG. 4C. The PA ET IC 464 may control the Vcc of the PA 461 according to the control of the communication processor 260 or the RFIC 410. The PA ET IC 464 may operate in a plurality of modes (e.g., an envelope tracking (ET) mode, an average power tracking (APT) mode, and a maximum power mode (e.g., APT full bias or battery direct)) according to the control of the communication processor 260 or the RFIC 410.

According to an embodiment, in the following description, the first RFFE 431 and/or the second RFFE 432 may be referred to as an RF circuit. According to an embodiment, the RF circuit may include an amplifier (e.g., a power amplifier PA), band pass filters (BPFs), a coupler, a switching circuit (e.g., a switch box or an antenna switch module (ASM)), or a low noise amplifier (LNA). According to an embodiment, the RF circuit may be referred to as an RFFE, a front end module (FEM), a power amplifier module (PAM), a power amplifier module with integrated duplexer (PAMID), a LNA PAMID (LPAMID), or a front end module with integrated duplexer (FEMid) depending on the function or the component included therein, but is not limited thereto.

According to an embodiment, as illustrated in FIG. 4C, the power amplifier 461 and the switch 470 may be included in one semiconductor chip or integrated circuit constituting the RF circuit (e.g., the first RFFE 431). According to an embodiment, the switch 470 may be configured as a separate module outside the RF circuit. According to an embodiment, the RF circuit may be configured as a semiconductor chip integrated with the above-described RFIC 410 or an integrated circuit. For example, the power amplifier 461 and/or the switch 470 included in the RF circuit may be configured as a semiconductor chip integrated with the RFIC 410 or an integrated circuit.

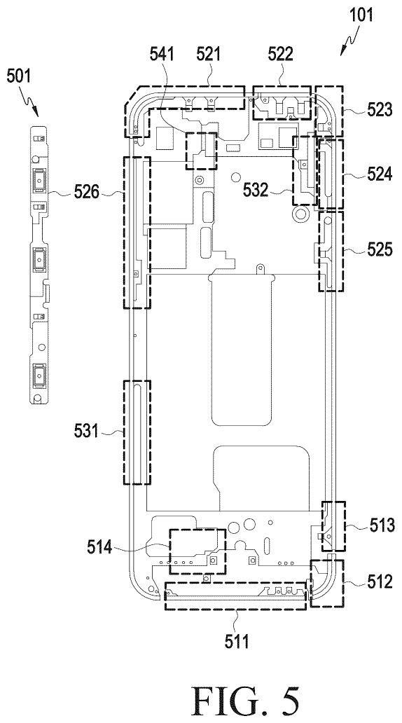

FIG. 5 is a view illustrating an antenna arrangement structure of an electronic device according to an embodiment of the disclosure. According to an embodiment, for 5G UEs, there are increasing standalone (SA) communication schemes, in which 5G NR (SUB6) may operate alone without LTE, as well as non-standalone communication schemes of LTE and NR (SUB6). As the cases in which 5G NR (SUB6) alone operates increase, there are being provided electronic devices including circuits and devices for supporting various new features of NR.

Referring to FIG. 5, an electronic device 101 may include a plurality of antennas 511, 512, 513, 514, 521, 522, 523, 524, 525, and 526 inside and/or in at least a portion of the housing forming the exterior of the electronic device 101.

According to various embodiments, the antennas 511, 512, 513, and 514 disposed at a lower portion of the electronic device 101 may be referred to as main antennas. Among the main antennas, a first main antenna 511 or a second main antenna 512 may be formed of metal at an outer portion of the housing. The first main antenna 511 may be used to transmit and receive 2G, 3G, LTE or NR signals. The second main antenna 512 may be used for transmission/reception of LTE signals or reception of NR signals.

According to various embodiments, a fourth main antenna 514 among the main antennas may be configured in the form of laser direct structuring (LDS) inside the housing. The fourth main antenna 514 may be used for reception of 3G, LTE, or NR signals. Among the main antennas, a third main antenna 513 may be configured in the form of LDS or a metal slit inside or in at least a portion of the housing. According to various embodiments, the second main antenna 512 may be used for transmission/reception of high-band (HB) signals (e.g., N41). The third main antenna 513 may be used for transmission/reception of ultra-high band (UHB) signals (e.g., N77, N78, and N79).

According to various embodiments, the antennas 521, 522, 523, 524, 525, and 526 disposed at an upper portion or side surfaces of the electronic device 101 may be referred to as sub antennas. At least one (e.g., a first sub antenna 521, a second sub antenna 522, a third sub antenna 523, a fourth sub antenna 524, a fifth sub antenna 525, and a sixth sub antenna 526) of the sub antennas may be formed of metal outside the housing or may be formed of a metal slit in at least a portion (e.g., a side key 501) of the housing. At least one antenna 521, 522, 523, 524, 525, and 526 of the sub antennas may be used to receive a 2G, 3G, LTE, or NR signal. According to an embodiment, the fifth sub antenna 525 may be used for receiving a GPS or Wi-Fi™ signal. The second sub antenna 522 or the third sub antenna 523 may be used to transmit and receive an

NR signal (e.g., N77, N78, or N79). According to an embodiment, a seventh sub antenna 541 may be configured in the form of an LDS inside the housing. According to an embodiment, an eighth sub antenna 531 and a ninth sub antenna 532 may be configured as mmWave modules. According to various embodiments, it will be readily understood by one of ordinary skill in the art that the arrangement and use of the antennas of the electronic device 101 are not limited to those shown and described above.

According to various embodiments, the electronic device may support multi-layers (e.g., 4×4 layers or more) and high modulation (e.g., 1024 quadrature amplitude modulation (QAM)) to enhance the throughput (T-PUT) and reception performance of downlink (DL), and may support complex and various EN-DC combinations to increase the reception bandwidth.

According to various embodiments, the electronic device may support uplink-multiple input multiple output (UL-MIMO) or uplink carrier aggregation (ULCA) to enhance uplink (UL) throughput and transmission performance, and may support power class 1.5 (PC1.5) to increase coverage. For example, the UL-MIMO may be configured to transmit different signals through a plurality of antennas, which is referred to as a first transmission mode for convenience in the following description. The PC1.5 may be configured to simultaneously transmit the same signal through a plurality of antennas (e.g., two antennas), which is referred to as a second transmission mode for convenience in the following description.

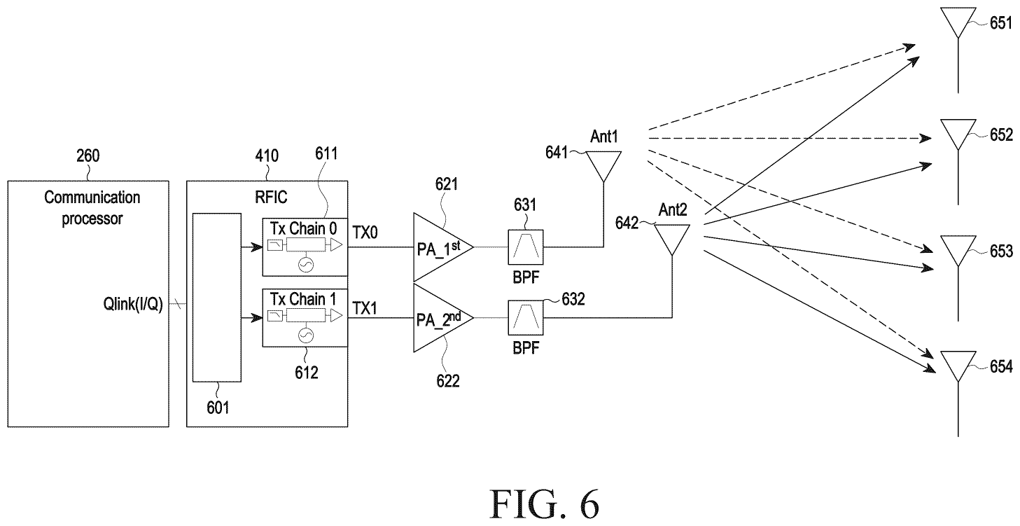

FIG. 6 is a block diagram illustrating an electronic device according to an embodiment of the disclosure.

Referring to FIG. 6, an electronic device (e.g., the electronic device 101 of FIG. 1) according to various embodiments may include a communication processor 260, an RFIC 410, a first PA 621 (e.g., a first RFFE), a second PA 622 (e.g., a second RFEE), a first band pass filter (BPF) 631, a second band pass filter 632, a first antenna (ANT1) 641, or a second antenna (ANT2) 642. The first PA 621 may be included in the first RFFE or the first RF circuit. In addition to the first PA 621, the first RF circuit may further include a first BPF 631, a low noise amplifier, or at least one switch. The second PA 622 may be included in the second RFFE or the second RF circuit. In addition to the second PA 622, the second RF circuit may further include a second BPF 632, a low noise amplifier, or at least one switch.

According to various embodiments, the RFIC 410 may include a signal processing circuit 601 and at least two Tx chains (e.g., a first transmission chain (Tx Chain 0) 611 and a second transmission chain (Tx Chain 1) 612). The signal processing circuit 601 may receive a baseband signal (e.g., a Qlink signal) from the communication processor 260, and may output first signals (or the first transmission signal TX0) for the first transmission chain 611 and second signals (or the second transmission signal TX1) for the second transmission chain 612, based on the electronic device operating in the UL-MIMO mode (e.g., the first transmission mode). The first signal and the second signal may be different signals from each other.

According to various embodiments, the first transmission chain 611 of the RFIC 410 may be connected to the first PA 621. The second transmission chain 612 of the RFIC 410 may be connected to the second PA 622. The RFIC 410 may transmit the first signal for UL-MIMO to the first PA 621 through the first transmission chain 611. The first signal transmitted from the RFIC 410 may be amplified by the first PA 621 and then transmitted to the communication network through the first antenna 641 via the first BPF 631. For example, the first signal transmitted through the first antenna 641 by the electronic device may be received by a plurality of reception antennas (e.g., a first reception antenna 651, second reception antenna 652, third reception antenna 653, or fourth reception antenna 654) of the base station.

According to various embodiments, the RFIC 410 may transmit the second signal for UL-MIMO to the second PA 622 through the second transmission chain 612. The second signal transmitted from the RFIC 410 may be amplified by the second PA 622 and then transmitted to the communication network through the second antenna 642 via the second BPF 632. For example, the second signal transmitted through the second antenna 642 by the electronic device may be received by a plurality of reception antennas (e.g., the first reception antenna 651, the second reception antenna 652, the third reception antenna 653, or the fourth reception antenna 654) of the base station.

According to various embodiments, as illustrated in FIG. 6, since the electronic device transmits different uplink data in each transmission chain to support UL-MIMO, when operating in UL 2×2 MIMO, the uplink throughput may be doubled. Accordingly, as network congestion may be reduced, and the network capacity is enhanced, the electronic device may provide the user with an uplink experience that is twice as fast. According to various embodiments, when the power class set in the electronic device is PC3, each of the first signal and the second signal may be transmitted at a maximum magnitude of 23 decibel milliwatts (dBm).

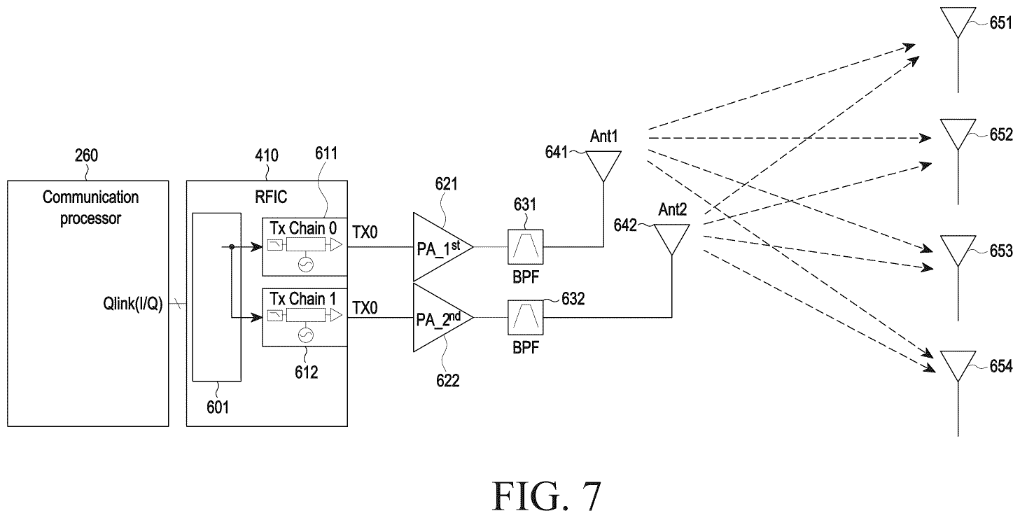

FIG. 7 is a block diagram illustrating an electronic device according to an embodiment of the disclosure.

Referring to FIG. 7, an electronic device (e.g., the electronic device 101 of FIG. 1) according to various embodiments may include a communication processor 260, an RFIC 410, a first PA 621 (e.g., a first RFFE), a second PA 622 (e.g., a second RFEE), a first band pass filter (BPF) 631, a second band pass filter 632, a first antenna (ANT1) 641, or a second antenna (ANT2) 642. The first PA 621 may be included in the first RFFE or the first RF circuit. In addition to the first PA 621, the first RF circuit may further include a first BPF 631, a low noise amplifier, or at least one switch. The second PA 622 may be included in the second RFFE or the second RF circuit. In addition to the second PA 622, the second RF circuit may further include a second BPF 632, a low noise amplifier, or at least one switch.

According to various embodiments, the RFIC 410 may include a signal processing circuit 601 and at least two Tx chains (e.g., first transmission chain (Tx Chain 0) 611 and second transmission chain (Tx Chain 1) 612). The signal processing circuit 601 may receive a baseband signal (e.g., a Qlink signal) from the communication processor 260, and may output first signals (or the first transmission signal TX0) for the first transmission chain 611 and second signals (or the second transmission signal TX1) for the second transmission chain 612, based on the electronic device operating in the PC1.5 mode (e.g., the second transmission mode). The first signal and the second signal may be the same signal. For example, based on the electronic device operating in the PC1.5 mode, the signal processing circuit 601 may divide the same uplink data (e.g., in-phase/quadrature (I/Q) data) by a splitter and simultaneously transmit the same to different transmission chains (e.g., the first transmission chain 611 and the second transmission chain 612). For example, when the same transmission I/Q data is modulated by a transmission phase locked loop (PLL) circuit in the RFIC 410, the same transmission I/Q data may be transmitted to the 1 layer through each antenna (e.g., the first antenna 641 and the second antenna 642).

According to various embodiments, the first transmission chain 611 of the RFIC 410 may be connected to the first PA 621. The second transmission chain 612 of the RFIC 410 may be connected to the second PA 622. The RFIC 410 may transmit the first signal for PC1.5 to the first PA 621 through the first transmission chain 611. The first signal transmitted from the RFIC 410 may be amplified by the first PA 621 and then transmitted to the communication network through the first antenna 641 via the first BPF 631. For example, the first signal transmitted through the first antenna 641 by the electronic device may be received by a plurality of reception antennas (e.g., the first reception antenna 651, the second reception antenna 652, the third reception antenna 653, or the fourth reception antenna 654) of the base station.

According to various embodiments, the RFIC 410 may transmit the second signal for PC1.5 to the second PA 622 through the second transmission chain 612. The second signal transmitted from the RFIC 410 may be amplified by the second PA 622 and then transmitted to the communication network through the second antenna 642 via the second BPF 632. For example, the second signal transmitted through the second antenna 642 by the electronic device may be received by a plurality of reception antennas (e.g., the first reception antenna 651, the second reception antenna 652, the third reception antenna 653, or the fourth reception antenna 654) of the base station.

According to various embodiments, as illustrated in FIG. 7, since the electronic device simultaneously transmits the same uplink data in each transmission chain to support PC1.5, it is possible to increase the output of the transmission signal. For example, as the electronic device operates in the second transmission mode corresponding to PC1.5, the electronic device may have an effect of transmitting with twice the transmission power, and theoretically (e.g., assuming that there is no path loss or interference), the coverage may be doubled. According to various embodiments, as the power class set in the electronic device is PC1.5, each of the first signal and the second signal may be transmitted at a maximum magnitude of 26 dBm. Accordingly, since the first signal and the second signal are the same signal, the electronic device may have an effect of transmitting a signal of 29 dBm. For example, the target power in PC1.5 may be represented as Equation 1 below.

$$PC 1.5 ( target power ) = PC 2 ( first transmission chain target power ) + PC 2 ( second transmission chain target power ) \qquad Equation 1$$

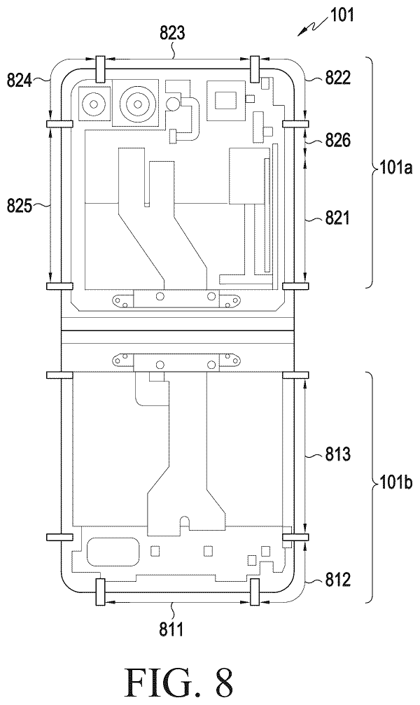

FIG. 8 is a view illustrating an antenna arrangement structure of an electronic device according to an embodiment of the disclosure.

Referring to FIG. 8, an electronic device 101 may include a first housing 101a (or a first housing portion or an upper body) and a second housing 101b (or a second housing portion or a lower body). The second housing 101b may be rotatably coupled to the first housing 101a. For example, the second housing may be configured to be movable with the first housing between a closed state and an open state. According to an embodiment, the electronic device 101 may include a plurality of antennas. The first housing 101a may include a plurality of conductive portions forming an outer side surface of the electronic device 101. At least one of the plurality of conductive portions of the first housing 101a may be used as an antenna. The second housing 101b may include a plurality of conductive portions forming an outer side surface of the electronic device 101. At least one of the plurality of conductive portions of the second housing 101b may be used as an antenna. For example, the electronic device 101 may include a first main antenna 811, a second main antenna 812, and a third main antenna 813 as three main antennas in the second housing 101b. The first main antenna 811 may process signals in a frequency band corresponding to a low band (LB) and a mid-band (MB). The second main antenna 812 may process signals in a frequency band corresponding to a high band (HB). The third main antenna 813 may process signals in a frequency band corresponding to a mid-band MB and a high band HB.

According to an embodiment, the electronic device 101 may include a first sub antenna 821, a second sub antenna 822, a third sub antenna 823, a fourth sub antenna 824, a fifth sub antenna 825, and a sixth sub antenna 826 as six sub antennas in the first housing 101a. The first sub antenna 821 may process signals in a frequency band corresponding to a high band HB or a low band LB. The second sub antenna 822 may process signals in a frequency band corresponding to a high band HB and a Wi-Fi™ signal. The third sub antenna 923 may process signals in a frequency band corresponding to a mid-band MB. The fourth sub antenna 924 may process a global positioning system (GPS) signal and a Wi-Fi™ signal. The fifth sub antenna 925 may process signals in a frequency band corresponding to a mid-band MB or a high band HB. In the above, frequency bands corresponding to the low band LB, the mid band MB, and the high band HB may be variously set by the operator. According to an embodiment, within a frequency band of 300 MHz to 300 GHz, a band of 1 GHz or less may be classified as a low band (LB), a band of 1 GHz to 6 GHz may be classified as a mid-band (MB), and a band of 6 GHz or more may be classified as a high band (HB), but this is merely an example and embodiments are not limited thereto. For example, the high band HB may be referred to as a frequency of 3.5 GHz or more.

According to various embodiments, an electronic device having a foldable form factor, an electronic device having a slidable form factor, or an electronic device having a rollable form factor as illustrated in FIG. 8 may have a transmission antenna configured to optimize performance according to the UL MIMO or PC1.5 mode and the state (e.g., an open state/closed state) of the electronic device. For example, in order to increase the performance of uplink throughput of the electronic device, it is required to be spatially sufficiently spaced apart and to secure sufficient isolation between two antennas for effective operation in a 2-layer environment. According to an embodiment, good isolation may be secured when it is spaced apart by the gap and space of not less than half (λ/2) of the wavelength (λ) of the free space. For example, when the N41 frequency is 2.5 GHZ, the wavelength is 0.12 meters (m), and the distance between the two antennas is larger than or equal to about 6 centimeters (cm), which is half the wavelength, sufficient isolation may be secured. For example, considering the length of the electronic device, optimal performance may be guaranteed when transmitting a 2-layer transmission signal through an upper/lower antenna or a left/right antenna.

According to various embodiments, in the case of 1 layer in which the electronic device is set as the PC1.5 mode, the two antennas transmit the same data and, thus, the radiation performance may be determined depending on the condition of the ground (GND) or adjustment of phase, rather than isolation between the antennas. For example, when set as the PC1.5 mode, two PAs simultaneously output with the high power of PC2 in the electronic device, causing, e.g., reduction in usage time due to heat generation and high current consumption.

According to various embodiments, when the form factor of the electronic device is of a bar type as shown in FIG. 5, assuming that the horizontal and vertical lengths are 150 millimeters (mm)×70 mm, a certain degree of isolation may be secured if the transmission antennas are arranged considering the frequency lengths in the upper/lower and left/right directions with respect to the metal housing antenna. When the form factor of the electronic device is of a foldable type, slidable type, or rollable type as shown in FIG. 8, the gap between the antennas may be varied, and they affect each other depending on the state or form (e.g., open state/closed state) of the electronic device, so that no isolation is secured, and uplink throughput may deteriorate.

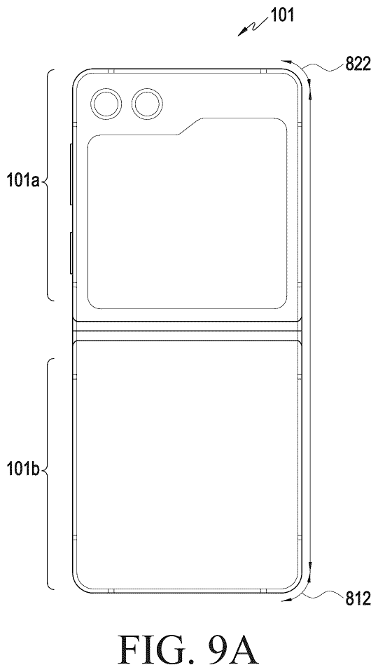

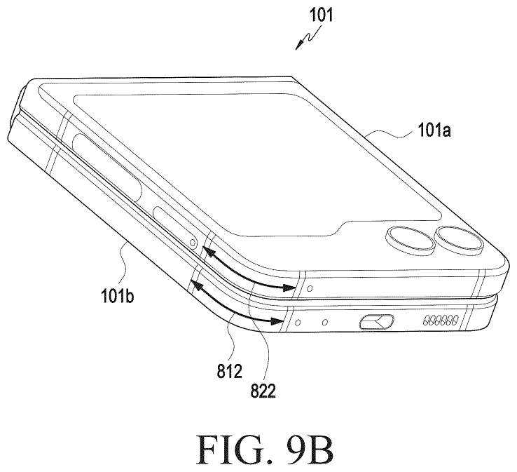

FIG. 9A is a view illustrating an outer appearance of an electronic device according to an embodiment of the disclosure.

Referring to FIG. 9A, an electronic device 101 may have an up/down foldable form factor as shown in FIG. 8. As shown in FIG. 9A, in the open state of the electronic device 101, sufficient isolation may be secured when the electronic device 101 operates in UL-MIMO. For example, as the electronic device 101 operates in UL-MIMO, the first antenna for transmitting the first signal may be set as the second sub antenna 822 disposed in the first housing 101a, and the second antenna for transmitting the second signal may be set as the second main antenna 812 disposed in the second housing 101b. For example, assuming that the transmission frequency band of the first signal and the second signal is N77, ½ of the wavelength (8 cm) corresponding to the frequency of N77 is 4 cm and, considering the distance (e.g., 14 cm) between the two antennas (e.g., the second sub antenna 822 and the second main antenna 812), sufficient isolation may be secured, thus avoiding deterioration of uplink throughput deterioration.

FIG. 9B is a view illustrating an outer appearance of an electronic device according to an embodiment of the disclosure.

Referring to FIG. 9B, an electronic device 101 may have an up/down foldable form factor as shown in FIG. 8. As shown in FIG. 9B, in the closed state of the electronic device 101, sufficient isolation may not be secured when the electronic device 101 operates in UL-MIMO. For example, in the closed state of the electronic device 101, if the electronic device 101 operates in UL-MIMO, as shown in FIG. 9B, the distance between the two antennas (e.g., the second sub antenna 822 and the second main antenna 812) is physically reduced (e.g., 3 millimeters (mm) or less), so that isolation between the antennas may not be secured. Accordingly, interference may occur between the transmission signals through the two antennas in the electronic device 101, causing performance deterioration on uplink.

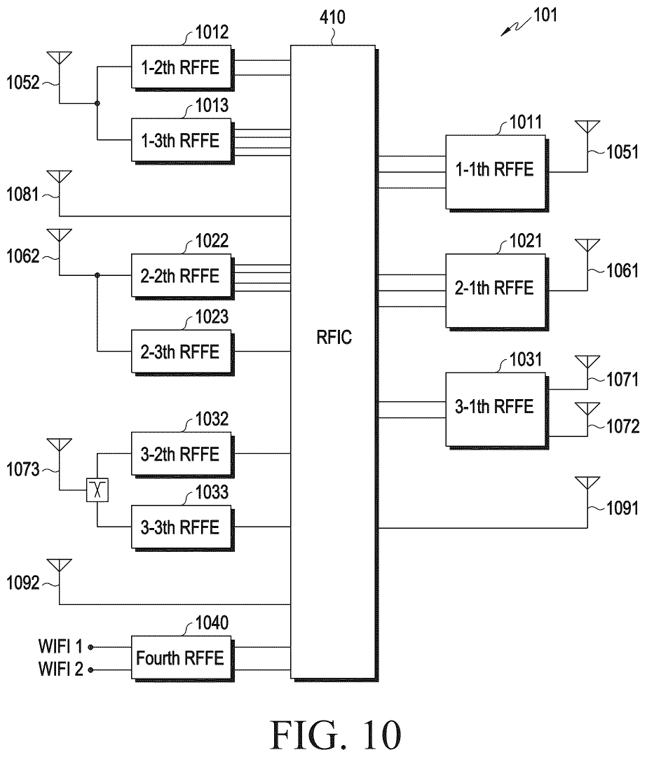

FIG. 10 is a block diagram illustrating an electronic device according to an embodiment of the disclosure.

Referring to FIG. 10, a plurality of RFFEs 1011, 1012, 1013, 1021, 1022, 1023, 1031, 1032, 1033, and 1040 may be connected to at least one RFIC (e.g., RFIC 410). The plurality of RFFEs 1011, 1012, 1013, 1021, 1022, 1023, 1031, 1032, 1033, and 1040 may be connected to a plurality of antennas 1051, 1052, 1061, 1062, 1071, 1072, 1073, 1081, 1091, and 1092.

According to various embodiments, a 1-1th RFFE 1011 and a 2-1th RFFE 1021 may be connected with a first main antenna 1051 and a second main antenna 1061, respectively. A 1-2th RFFE 1012 and a 1-3th RFFE 1013 may be connected with a first sub antenna 1052 to provide diversity with the first main antenna 1051. A 2-2th RFFE 1022 and a 2-3th RFFE 1023 may be connected with a second sub antenna 1062 to provide diversity with the second main antenna 1061. A 3-1th RFFE 1031 may be connected with two third main antennas 1071 and 1072 to provide MIMO. Further, a 3-2th RFFE 1032 and a 3-3th RFFE 1033 may be connected with a third sub antenna 1073 through a duplexer to provide MIMO or diversity with the third main antennas 1071 and 1072. A fifth antenna 1081 may be directly connected to the RFIC 410 without passing through an RFFE. A 6-1th antenna 1091 and a 6-2th antenna 1092 may also be directly connected to the RFIC 410 without passing through a RFFE and may provide MIMO or diversity through two antennas. The fourth RFFE 1040 may be connected to two Wi-Fi™ antennas (e.g., Wi-Fi 1 and Wi-Fi 2).

According to various embodiments, at least one of the RFFEs of FIG. 10 may correspond to any one of the first RFFE 431 and the second RFFE 432 described above with reference to FIG. 4A, 4B, or 4C. At least one of the antennas of FIG. 10 may correspond to any one of the plurality of antennas described above in connection with FIG. 4A, 4B, 4C, 5, or 8.

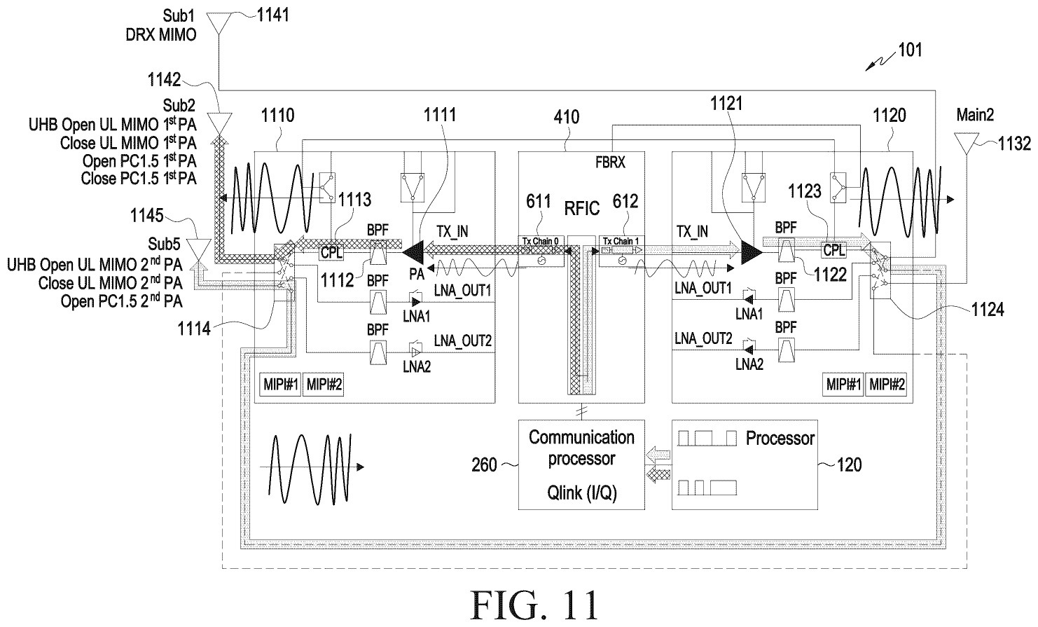

FIG. 11 is a block diagram illustrating an electronic device according to an embodiment of the disclosure.

Referring to FIG. 11, an electronic device (e.g., the electronic device 101 of FIG. 1) may include a processor 120, a communication processor 260, an RFIC 410, a first RF circuit 1110 (or a first RFFE), a second RF circuit 1120 (or a second RFFE), a second main antenna 1132 (e.g., the second main antenna 812 of FIG. 8), a first sub antenna 1141 (e.g., the first sub antenna 821 of FIG. 8), a second sub antenna 1142 (e.g., the second sub antenna 822 of FIG. 8), and a fifth sub antenna 1145 (e.g., the fifth sub antenna 825 of FIG. 8). According to various embodiments, the first RF circuit 1110 may include a first PA 1111, a first BPF 1112, a first coupler 1113, and a first switch 1114. The second RF circuit 1120 may include a second PA 1121, a second BPF 1122, a second coupler 1123, and a second switch 1124. In the embodiments described below, a specific frequency band or a specific antenna is provided as an example to help understanding, and various embodiments described below are not limited to the specific frequency band or the specific antenna.

According to an embodiment, as illustrated in FIG. 11, the first power amplifier 1111, the first BPF 1112, the first coupler 1113, and the first switch 1114 may be included in one semiconductor chip or integrated circuit constituting the first RF circuit 1110 (or the first RFFE). According to an embodiment, the first switch 1114 may be configured as a separate module outside the first RF circuit 1110. According to an embodiment, the first RF circuit 1110 may be configured as a semiconductor chip integrated with the above-described RFIC 410 or an integrated circuit. For example, the first power amplifier 1111 and/or the first switch 1114 included in the first RF circuit 1110 may be configured as a semiconductor chip integrated with the RFIC 410 or an integrated circuit.

According to an embodiment, as illustrated in FIG. 11, the second power amplifier 1121, the second BPF 1122, the second coupler 1123, and the second switch 1124 may be included in one semiconductor chip or integrated circuit constituting the second RF circuit 1210 (or the second RFFE). According to an embodiment, the second switch 1124 may be configured as a separate module outside the second RF circuit 1120. According to an embodiment, the second RF circuit 1120 may be configured as a semiconductor chip integrated with the above-described RFIC 410 or an integrated circuit. For example, the second power amplifier 1121 and/or the second switch 1124 included in the second RF circuit 1120 may be configured as a semiconductor chip integrated with the RFIC 410 or an integrated circuit.

According to various embodiments, the electronic device 101 may operate in UL-MIMO. For example, the electronic device 101 may identify a configuration message (e.g., a radio resource control (RRC) reconfiguration message) received from the communication network and operate in UL-MIMO.

According to various embodiments, the RFIC 410 may include a signal processing circuit (e.g., the signal processing circuit 601 of FIG. 6) and at least two Tx chains (e.g., first transmission chain (Tx Chain 0) 611 and second transmission chain (Tx Chain 1) 612). The signal processing circuit may receive a baseband signal (e.g., a Qlink signal) from the communication processor 260, and may output first signals (or the first transmission signal TX0) for the first transmission chain 611 and second signals (or the second transmission signal TX1) for the second transmission chain 612, based on the electronic device operating in the UL-MIMO mode (e.g., the first transmission mode). The first signal and the second signal may be different signals from each other.

According to various embodiments, the first transmission chain 611 of the RFIC 410 may be connected to the first PA 1111. The second transmission chain 612 of the RFIC 410 may be connected to the second PA 1121. The RFIC 410 may transmit the first signal for UL-MIMO to the first PA 1111 through the first transmission chain 611. The first signal transmitted from the RFIC 410 may be amplified by the first PA 621 and then transmitted to the communication network through the second sub antenna 1142 via the first BPF 1112, the first coupler 1113, and the first switch 1114.

According to various embodiments, the RFIC 410 may transmit the second signal for UL-MIMO to the second PA 1121 through the second transmission chain 612. The second signal transmitted from the RFIC 410 may be amplified by the second PA 1121 and then transmitted to the communication network through the fifth sub antenna 1145 via the second BPF 1122, the second coupler 1123, the second switch 1124, and the first switch 1114.

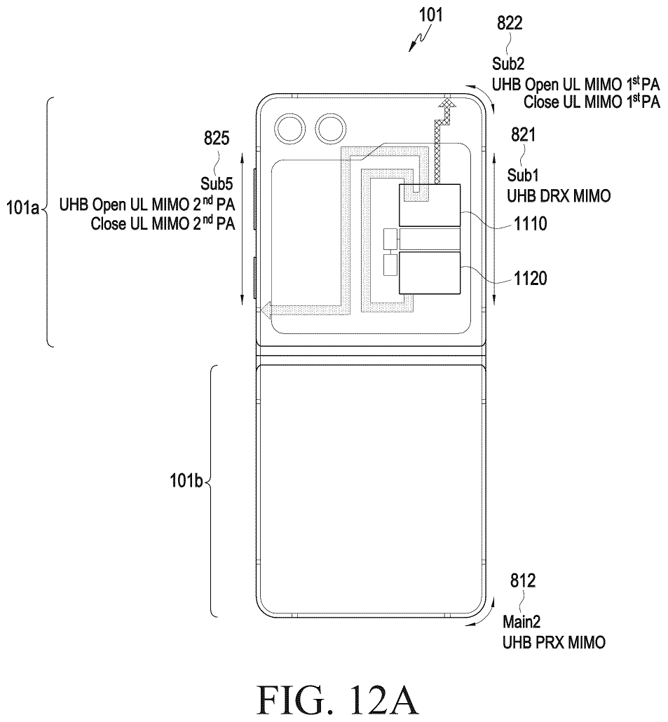

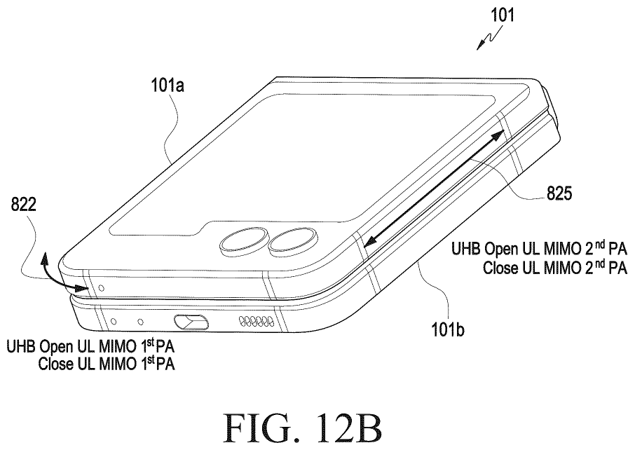

FIG. 12A is a view illustrating a transmission signal transmission path of an electronic device according to an embodiment of the disclosure.

Referring to FIG. 12A, as described above with reference to FIG. 11, as an electronic device 101 operates in UL-MIMO, the first signal may be transmitted through the second sub antenna 822, and the second signal may be transmitted through the fifth sub antenna 825.

As shown in FIG. 12A, in the open state of the electronic device 101, sufficient isolation may be secured when the electronic device 101 operates in UL-MIMO. For example, as the electronic device 101 operates in UL-MIMO, as described above, the first antenna for transmitting the first signal may be set as the second sub antenna 822 disposed in the first housing 101a, and the second antenna for transmitting the second signal may be set as the fifth sub antenna 825 disposed in the first housing 101a. For example, assuming that the transmission frequency band of the first signal and the second signal is N77, ½ of the wavelength (8 cm) corresponding to the frequency of N77 is 4 cm and, considering the distance between the two antennas (e.g., the second sub antenna 822 and the fifth sub antenna 825), sufficient isolation may be secured.

According to various embodiments, while the electronic device 101 operates in UL-MIMO, the electronic device may be changed from the open state to the closed state. For example, the processor 120 (e.g., an application processor) may identify the state of the electronic device 101 and may transmit a state flag corresponding to the current state to the communication processor 260. For example, when the electronic device 101 is in the open state, the state flag may be set to 0, and when the electronic device 101 is in the closed state, the state flag may be set to 1. According to various embodiments, the processor 120 may set the state flag by calculating the position of the electronic device 101 by the acceleration sensor or by identifying the state of the electronic device 101 through a hall IC. According to various embodiments, the processor 120 may transfer state information corresponding to the form of the electronic device 101 to the communication processor 260 in the form of a state flag as a device status index (DSI). The communication processor 260 may identify the current state (e.g., the open state or the closed state) of the electronic device 101, based on the state flag received from the processor 120.

FIG. 12B is a perspective view illustrating an electronic device according to an embodiment of the disclosure.

Referring to FIG. 12B, sufficient isolation may be secured even when electronic device 101 is changed from the open state to the closed state while operating in UL-MIMO. For example, as the electronic device 101 operates in UL-MIMO, as described above, the first antenna for transmitting the first signal may be set as the second sub antenna 822 disposed in the first housing 101a, and the second antenna for transmitting the second signal may be set as the fifth sub antenna 825 disposed in the first housing 101a. For example, assuming that the transmission frequency band of the first signal and the second signal is N77, ½ of the wavelength (8 cm) corresponding to the frequency of N77 is 4 cm and, considering the distance between the two antennas (e.g., the second sub antenna 822 and the fifth sub antenna 825), sufficient isolation may be secured although the electronic device 101 is changed into the closed state.

Referring to FIGS. 12A and 12B, it is possible to select or set two antennas that maximize the antenna gain or secure sufficient isolation between antennas corresponding to each state as the state of the electronic device is changed while the electronic device 101 operates in UL-MIMO. The processor 120 or the communication processor 260 of the electronic device 101 may control the transmission paths of the first signal and the second signal so that the first signal and the second signal may be transmitted to the corresponding antennas according to the configuration of the antenna. For example, the processor 120 or the communication processor 260 of the electronic device 101 may control the transmission paths of the first signal and the second signal by controlling the first switch 1114 and/or the second switch 1124 through mobile industry processor interface (MIPI) communication or general purpose input/output (GPIO) interface communication.

According to various embodiments, when isolation is secured between the two antennas while the electronic device 101 operates in UL-MIMO, it may be identified that the throughput is increased as shown in Table 1 below.

TABLE 1

| | UL-MIMO ON | | UL-MIMO OFF | |
|---|---|---|---|---|
| | download | upload | download | upload |
| | (Mbps) | (Mbps) | (Mbps) | (Mbps) |
| isolation secured | 1073.2 | 148.4 | 1027.4 | 111.2 |
| (spacing between | | | | |
| antennas) (SUB2-SUB5) | | | | |
| isolation not | 1034.2 | 114.2 | 1024.8 | 110.8 |
| secured (adjacent | | | | |
| antennas) (SUB2-SUB1) | | | | |

Referring to Table 1, it may be identified that while the electronic device 101 is operating in UL-MIMO, the throughput when isolation between antennas is not secured is 114.2 megabits per second (Mbps), but the throughput when isolation between antennas is secured is increased to 148.4 Mbps.

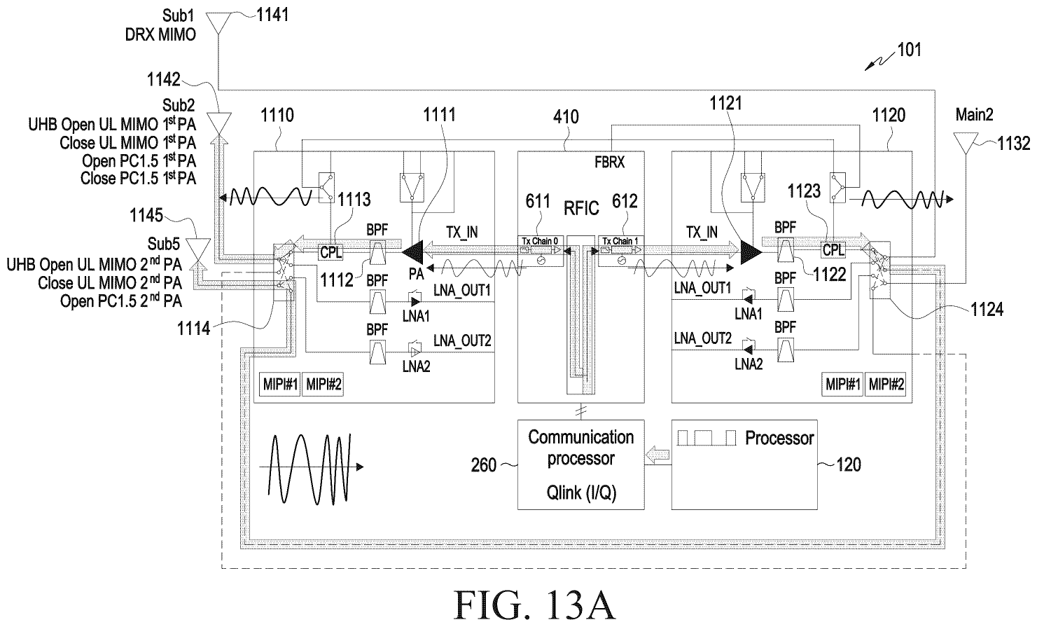

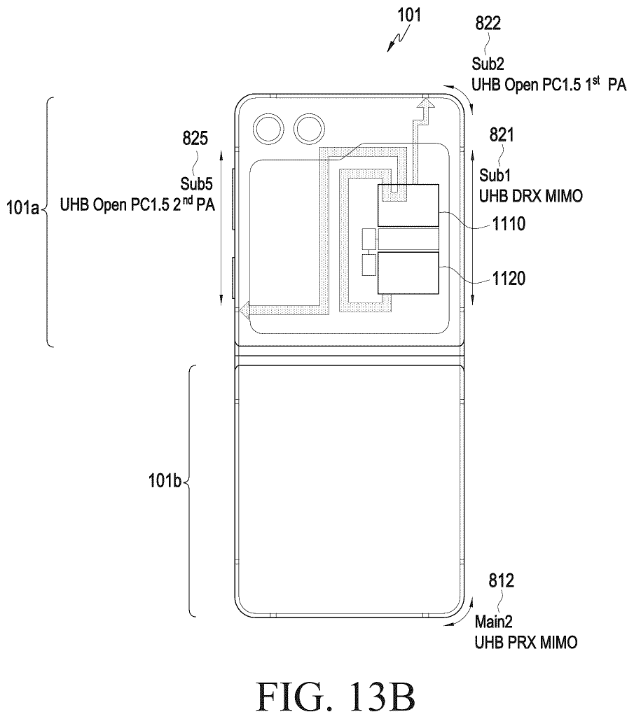

FIG. 13A is a block diagram illustrating an electronic device according to an embodiment of the disclosure.

Referring to FIG. 13A, an electronic device (e.g., the electronic device 101 of FIG. 1) may include a processor 120, a communication processor 260, an RFIC 410, a first RF circuit 1110 (or a first RFFE), a second RF circuit 1120 (or a second RFFE), a second main antenna 1132 (e.g., the second main antenna 812 of FIG. 8), a first sub antenna 1141 (e.g., the first sub antenna 821 of FIG. 8), a second sub antenna 1142 (e.g., the second sub antenna 822 of FIG. 8), and a fifth sub antenna 1145 (e.g., the fifth sub antenna 825 of FIG. 8). According to various embodiments, the first RF circuit 1110 may include a first PA 1111, a first BPF 1112, a first coupler 1113, and a first switch 1114. The second RF circuit 1120 may include a second PA 1121, a second BPF 1122, a second coupler 1123, and a second switch 1124.

According to various embodiments, the electronic device 101 may operate in PC1.5. For example, the electronic device 101 may identify a configuration message (e.g., a radio resource control (RRC) reconfiguration message) received from the communication network and operate in PC1.5.

According to various embodiments, the RFIC 410 may include a signal processing circuit (e.g., the signal processing circuit 601 of FIG. 6) and at least two Tx chains (e.g., first transmission chain (Tx Chain 0) 611 and second transmission chain (Tx Chain 1) 612). The signal processing circuit may receive a baseband signal (e.g., a Qlink signal) from the communication processor 260, and may output first signals (or the first transmission signal TX0) for the first transmission chain 611 and second signals (or the second transmission signal TX1) for the second transmission chain 612, based on the electronic device operating in the PC1.5 mode (e.g., the second transmission mode). The first signal and the second signal may be the same signal. For example, based on the electronic device operating in the PC1.5 mode, the signal processing circuit may divide the same uplink data (e.g., I/Q data) by a splitter and simultaneously transmit the same to different transmission chains (e.g., the first transmission chain 611 and the second transmission chain 612).

According to various embodiments, the first transmission chain 611 of the RFIC 410 may be connected to the first PA 1111. The second transmission chain 612 of the RFIC 410 may be connected to the second PA 1121. The RFIC 410 may transmit the first signal for PC1.5 to the first PA 1111 through the first transmission chain 611. The first signal transmitted from the RFIC 410 may be amplified by the first PA 1111 and then transmitted to the communication network through the second sub antenna 1142 via the first BPF 1112, the first coupler 1113, and the first switch 1114.

According to various embodiments, the RFIC 410 may transmit the second signal for PC1.5 to the second PA 1121 through the second transmission chain 612. The second signal transmitted from the RFIC 410 may be amplified by the second PA 1121 and then transmitted to the communication network through the fifth sub antenna 1145 via the second BPF 1122, the second coupler 1123, the second switch 1124, and the first switch 1114.

FIG. 13B is a view illustrating a transmission signal transmission path of an electronic device according to an embodiment of the disclosure.

Referring to FIG. 13B, as described above with reference to FIG. 13A, as an electronic device 101 operates in PC1.5, the first signal may be transmitted through the second sub antenna 822, and the second signal may be transmitted through the fifth sub antenna 825.

As illustrated in FIG. 13B, in the open state of the electronic device 101, when operating in PC1.5, an antenna having the highest efficiency of transmission diversity may be selected. For example, as the electronic device 101 operates in PC1.5, as described above, the first antenna for transmitting the first signal may be set as the second sub antenna 822 disposed in the first housing 101a, and the second antenna for transmitting the second signal may be set as the fifth sub antenna 825 disposed in the first housing 101a. According to various embodiments, in the open state of the electronic device 101, the same antenna combination (e.g., the second sub antenna 822 and the fifth sub antenna 825) may be selected or configured for UL-MIMO and PC1.5 as illustrated in FIGS. 12A and 13B. According to various embodiments, in the open state of the electronic device 101, different combinations of antennas may be selected or configured for UL-MIMO and PC1.5, unlike those illustrated in FIGS. 12A and 13B.

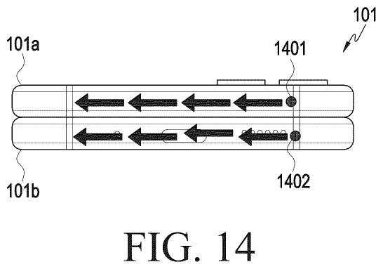

FIG. 14 is a view illustrating a transmission signal transmission path of an electronic device according to an embodiment of the disclosure.

Referring to FIG. 14, when electronic device 101 is changed from the open state to the closed state while operating in PC1.5, two antennas overlapping each other or symmetrical to each other may be selected or configured, unlike the UL-MIMO described above.

According to various embodiments, while the electronic device 101 operates in PC1.5, in the closed state, the electronic device 101 may form the same current direction by forming feeding at the same or adjacent positions between different antennas. For example, when the electronic device 101 operates in PC1.5, as illustrated in FIG. 14, it is possible to minimize the offset effect of current flows by selecting or configuring antennas where first feeding 1401 of the first antenna transmitting the first signal and second feeding 1402 of the second antenna transmitting the second signal overlap each other, thereby increasing the efficiency of power (e.g., total radiation power (TRP)) radiated through the antenna. According to various embodiments, the technique of increasing the efficiency of the power radiated through the antenna by forming the same current direction by forming feeding at the same or adjacent positions between the different antennas may be referred to as an equivalent phase antenna (EPA) scheme, but the disclosure is not limited to the technique or the terms.

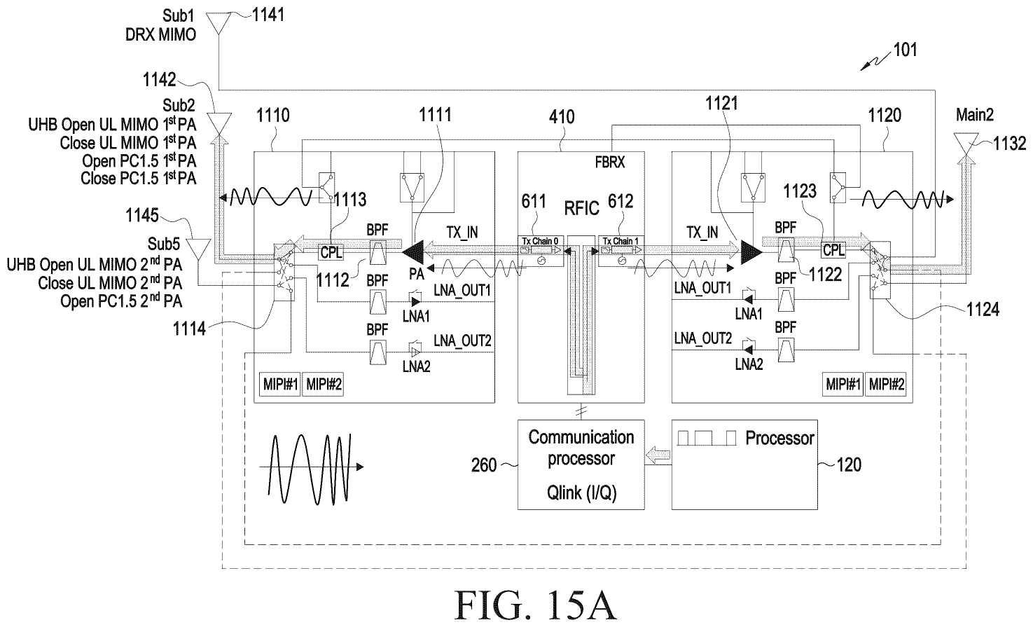

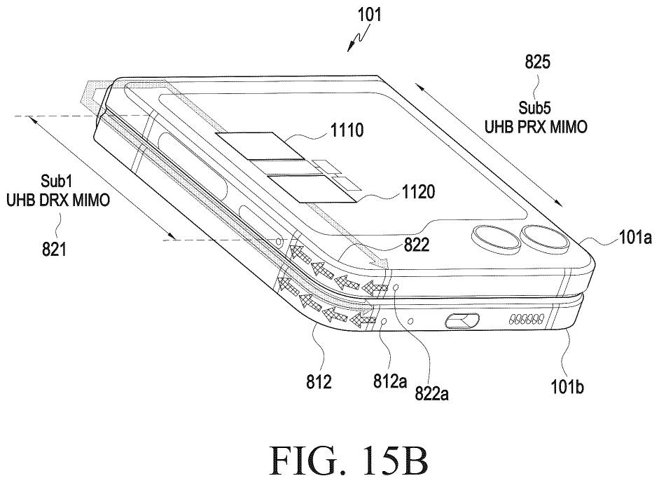

FIG. 15A is a block diagram illustrating an electronic device according to an embodiment of the disclosure.

Referring to FIG. 15A, an electronic device (e.g., the electronic device 101 of FIG. 1) may include a processor 120, a communication processor 260, an RFIC 410, a first RF circuit 1110 (or a first RFFE), a second RF circuit 1120 (or a second RFFE), a second main antenna 1132 (e.g., the second main antenna 812 of FIG. 8), a first sub antenna 1141 (e.g., the first sub antenna 821 of FIG. 8), a second sub antenna 1142 (e.g., the second sub antenna 822 of FIG. 8), and a fifth sub antenna 1145 (e.g., the fifth sub antenna 825 of FIG. 8). According to various embodiments, the first RF circuit 1110 may include a first PA 1111, a first BPF 1112, a first coupler 1113, and a first switch 1114. The second RF circuit 1120 may include a second PA 1121, a second BPF 1122, a second coupler 1123, and a second switch 1124.

According to various embodiments, the electronic device 101 may operate in PC1.5. For example, the electronic device 101 may identify a configuration message (e.g., a radio resource control (RRC) reconfiguration message) received from the communication network and operate in PC1.5.

According to various embodiments, the RFIC 410 may include a signal processing circuit (e.g., the signal processing circuit 601 of FIG. 6) and at least two Tx chains (e.g., first transmission chain (Tx Chain 0) 611 and second transmission chain (Tx Chain 1) 612). The signal processing circuit may receive a baseband signal (e.g., a Qlink signal) from the communication processor 260, and may output first signals (or the first transmission signal TX0) for the first transmission chain 611 and second signals (or the second transmission signal TX1) for the second transmission chain 612, based on the electronic device operating in the PC1.5 mode (e.g., the second transmission mode). The first signal and the second signal may be the same signal. For example, based on the electronic device operating in the PC1.5 mode, the signal processing circuit may divide the same uplink data (e.g., I/Q data) by a splitter and simultaneously transmit the same to different transmission chains (e.g., the first transmission chain 611 and the second transmission chain 612).

According to various embodiments, the first transmission chain 611 of the RFIC 410 may be connected to the first PA 1111. The second transmission chain 612 of the RFIC 410 may be connected to the second PA 1121. The RFIC 410 may transmit the first signal for PC1.5 to the first PA 1111 through the first transmission chain 611. The first signal transmitted from the RFIC 410 may be amplified by the first PA 1111 and then transmitted to the communication network through the second sub antenna 1142 via the first BPF 1112, the first coupler 1113, and the first switch 1114.

According to various embodiments, the RFIC 410 may transmit the second signal for PC1.5 to the second PA 1121 through the second transmission chain 612. The second signal transmitted from the RFIC 410 may be amplified by the second PA 1121 and then transmitted to the communication network through the second main antenna 1132 via the second BPF 1122, the second coupler 1123, and the second switch 1124.

FIG. 15B is a view illustrating a transmission signal transmission path of an electronic device according to an embodiment of the disclosure.

Referring to FIG. 15B, when an electronic device 101 is changed from the open state to the closed state while operating in PC1.5, two antennas overlapping each other or symmetrical to each other may be selected or configured, unlike the UL-MIMO described above.

According to various embodiments, while the electronic device 101 operates in PC1.5, in the closed state, the electronic device 101 may form the same current direction by forming feeding at the same or adjacent positions between different antennas. For example, as illustrated in FIG. 15B, it may be identified that in the closed state of the electronic device 101, a first feeding 822a of the second sub antenna 822 disposed in the first housing 101a and a second feeding 812a of the second main antenna 812 disposed in the second housing 101b overlap each other and are formed at the same or adjacent positions. As described above with reference to FIG. 15A, according to various embodiments, while the electronic device 101 operates in PC1.5, in the closed state, the electronic device 101 may control to transmit the first signal through the second sub antenna 822 and transmit the second signal through the second main antenna 812, thereby maximizing radiated power (e.g., TRP).

According to various embodiments, in the closed state while the electronic device 101 operates in PC1.5, the second sub antenna 822 disposed in the first housing 101a and the second main antenna 812 disposed in the second housing 101b may at least partially overlap each other. For example, the position of the first feeding 822a of the second sub antenna 822 and the position of the second feeding 812a of the second main antenna 812 may be formed so that the current direction of the second sub antenna 822 disposed in the first housing 101a and the current direction of the second main antenna 812 disposed in the second housing 101b are the same. For example, as described above, the RFIC 410 of the electronic device 101 may adjust the phase of the first signal and the phase of the second signal output through each configured antenna to the same phase and apply the EPA technique. Thus, it may be identified that the transmission performance (e.g., TRP) is enhanced as shown in Table 2 below.

TABLE 2

| | measurement | | n41 | n77 | n79 |
|---|---|---|---|---|---|
| | case | antenna | TRP | TRP | TRP |
| EPA not | transmission | PC2(1st) | 26 | 26 | 25.5 |
| applied | power | PC2(2nd) | 26 | 26 | 25.5 |
| | | PC1.5(SUM) | 29 | 29 | 28.5 |
| | closed state | UL-MIMO | 23.5 | 22.5 | 20.5 |
| | (Sub2-Sub5) | | | | |
| EPA | transmission | PC2(1st) | 26 | 26.3 | 25.5 |
| applied | power | PC2(2nd) | 26 | 25.3 | 25 |
| | | PC1.5(SUM) | 29 | 28.8 | 28.2 |
| | closed state | EPA | 25.5 | 24.1 | 21.3 |
| | (Sub2-Main2) | | | | |

| | | | |
|---|---|---|---|
| enhanced amount (Δ) | 2 | 1.6 | 0.8 |

Referring to Table 2, it may be identified that when the electronic device 101 operates in PC1.5 in the closed state, an enhancing effect of about 1 to 2 dB or more is presented by applying the EPA.

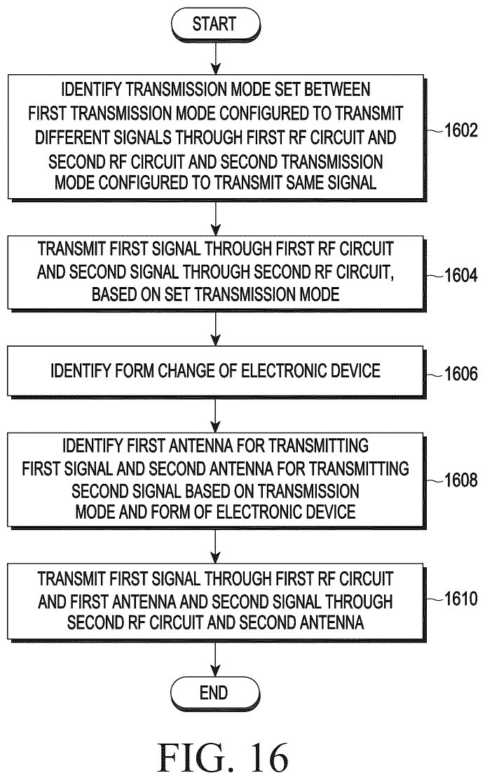

FIG. 16 is a flowchart illustrating an operation method of an electronic device according to an embodiment of the disclosure.

In the following embodiments, each operation may be performed sequentially, but is not necessarily performed sequentially. For example, the order of the operations may be changed, and at least two operations may be performed in parallel.

Referring to FIG. 16, according to various embodiments, in operation 1602, an electronic device 101 (e.g., at least one of the processor 120 of FIG. 1, the first communication processor 212 of FIG. 2A, the second communication processor 214 of FIG. 2A, or the integrated communication processor 260 of FIG. 2B or FIG. 2C) may identify a transmission mode currently set between a first transmission mode (e.g., UL-MIMO) set to transmit different signals through the first RF circuit and the second RF circuit and a second transmission mode (e.g., PC1.5) set to transmit the same signal. For example, the electronic device 101 may identify the set transmission mode based on a configuration message (e.g., a radio resource control (RRC) reconfiguration message) received through the communication network.

According to an embodiment, the electronic device 101 may control to transmit the first signal via the first RF circuit and concurrently transmit the second signal via the second RF circuit, based on the transmission mode, in operation 1604.

According to various embodiments, the electronic device 101 may identify that the form of the electronic device is changed, in operation 1606. For example, the electronic device 101 may set the state flag by calculating the position of the electronic device 101 by the acceleration sensor or by identifying the state of the electronic device 101 through a hall IC. According to various embodiments, the processor 120 of the electronic device 101 may transfer state information corresponding to the form of the electronic device 101 to the communication processor 260 in the form of a state flag as a device status index (DSI). The communication processor 260 may identify the current state (e.g., the open state or the closed state) or form change of the electronic device 101, based on the state flag received from the processor 120.

According to various embodiments, in operation 1608, the electronic device 101 may select or identify a first antenna for transmitting the first signal and a second antenna for transmitting the second signal, based on the transmission mode (e.g., UL-MIMO or PC1.5) and the form of the electronic device (e.g., the open state or the closed state). For example, based on identifying that the transmission mode is the second transmission mode and the form of the electronic device is changed to the closed state, the electronic device may select or identify the first antenna and the second antenna, the feeding positions of which are adjacent to each other. Based on identifying that the transmission mode is the second transmission mode and the form of the electronic device is changed to the closed state, the electronic device may select or identify the first antenna and the second antenna meeting an equivalent phase antenna (EPA) condition. Based on identifying that the transmission mode is the second transmission mode and the form of the electronic device is changed to the open state, the electronic device may select or identify the first antenna and the second antenna that maximize the transmission diversity efficiency. Based on identifying that the transmission mode is the first transmission mode and the form of the electronic device is changed to the open state or the closed state, the electronic device may select or identify the first antenna and the second antenna to maintain isolation between antennas or to maximize antenna gain.

According to an embodiment, the electronic device 101 may control to transmit the first signal via the first RF circuit and the first antenna and concurrently transmit the second signal via the second RF circuit and the second antenna, in operation 1610.

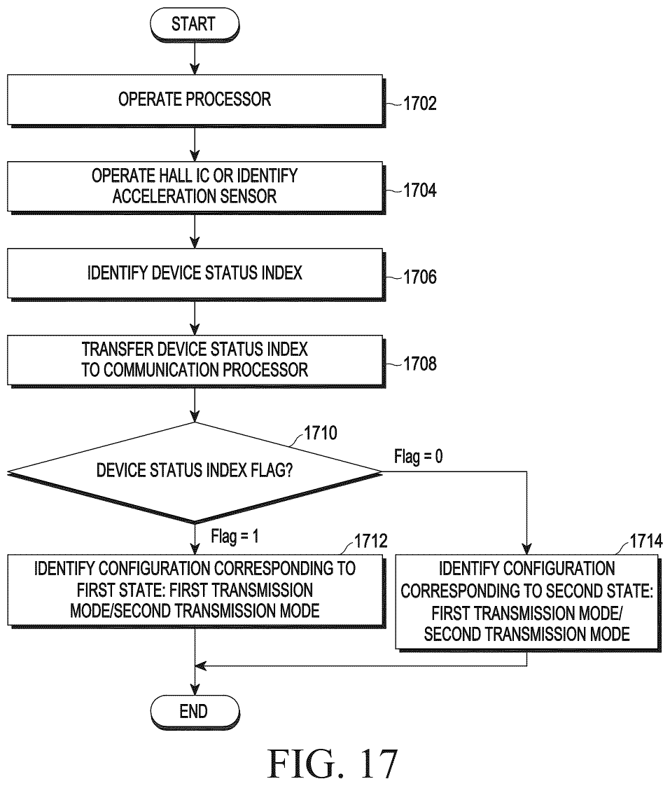

FIG. 17 is a flowchart illustrating an operation method of an electronic device according to an embodiment of the disclosure.

In the following embodiments, each operation may be performed sequentially, but is not necessarily performed sequentially. For example, the order of the operations may be changed, and at least two operations may be performed in parallel.

Referring to FIG. 17, according to various embodiments, an electronic device 101 (e.g., at least one of the processor 120 of FIG. 1, the first communication processor 212 of FIG. 2A, the second communication processor 214 of FIG. 2A, or the integrated communication processor 260 of FIG. 2B or FIG. 2C) may operate to identify the state of the electronic device 101, in operation 1702.

According to various embodiments, in operation 1704, the processor 120 may calculate the position of the electronic device 101 by the acceleration sensor or may identify the state of the electronic device 101 through a hall IC. According to various embodiments, in operation 1706, the processor 120 may identify or set a state flag or a state index based on the sensed state.

According to various embodiments, in operation 1708, the processor 120 may transfer state information corresponding to the form of the electronic device 101 to the communication processor 260 in the form of a state flag as a device state index (e.g., a device status index (DSI)). For example, when the electronic device 101 is in the open state, the state flag may be set to 0, and when the electronic device 101 is in the closed state, the state flag may be set to 1.

According to various embodiments, in operation 1710, the communication processor 260 may identify the flag of the device status index transferred from the processor 120. As a result of the identification, when the flag is set to 1 (Flag=1), the communication processor 260 may determine that the state is the first state (e.g., the closed state) and, in operation 1712, may identify the configuration (e.g., the configuration of the first antenna and the second antenna) corresponding to the first state and the corresponding transmission mode (e.g., the first transmission mode UL-MIMO or the second transmission mode PC1.5). As a result of the identification, when the flag is set to 0 (Flag=0), the communication processor 260 may determine that the state is the second state (e.g., the open state) and, in operation 1714, may identify the configuration (e.g., the configuration of the first antenna and the second antenna) corresponding to the second state and the corresponding transmission mode (e.g., the first transmission mode UL-MIMO or the second transmission mode PC1.5).

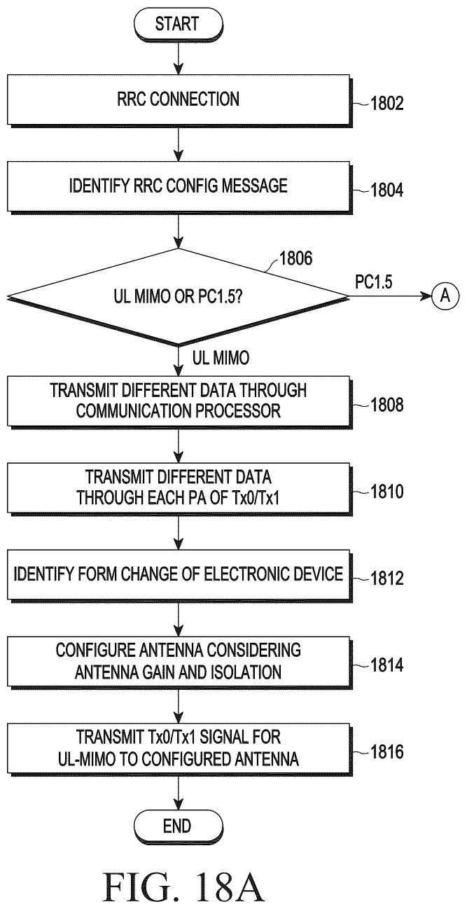

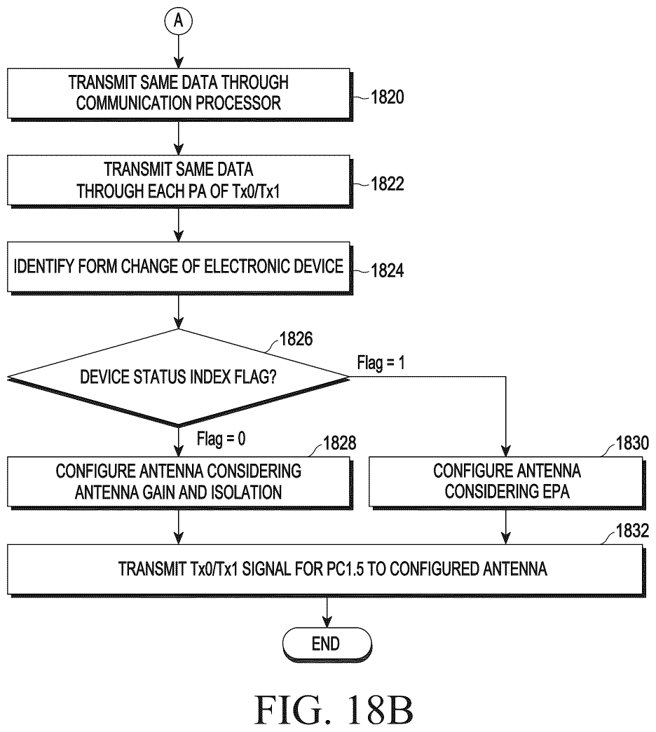

FIG. 18A is a flowchart illustrating a method for operating an electronic device according to an embodiment of the disclosure, and FIG. 18B is a flowchart illustrating a method for operating an electronic device according to an embodiment of the disclosure.

In the following embodiments, each operation may be performed sequentially, but is not necessarily performed sequentially. For example, the order of the operations may be changed, and at least two operations may be performed in parallel.

Referring to FIGS. 18A and 18B, according to various embodiments, an electronic device 101 (e.g., at least one of the processor 120 of FIG. 1, the first communication processor 212 of FIG. 2A, the second communication processor 214 of FIG. 2A, or the integrated communication processor 260 of FIG. 2B or FIG. 2C) may perform RRC connection with the communication network, in operation 1802.

According to various embodiments, in operation 1804, the electronic device 101 may identify an RRC configuration message (e.g., an RRC reconfiguration message) received from the communication network according to the RRC connection.

According to various embodiments, when the identified RRC configuration message includes a configuration corresponding to UL-MIMO, in operation 1806, the electronic device 101 may transmit different data through the communication processor (e.g., the communication processor 260), in operation 1808. According to various embodiments, in operation 1810, the electronic device 101 may transmit the different data through the respective connected PAs through the first transmission chain and the second transmission chain.

According to various embodiments, the electronic device 101 may identify a change in the form of the electronic device, in operation 1812. For example, the electronic device 101 may identify that the form of the electronic device is changed from the open state to the closed state, or from the closed state to the open state.

According to various embodiments, in operation 1814, the electronic device 101 may select or configure a first antenna for transmitting a first signal and a second antenna for transmitting a second signal considering antenna gain and isolation.

According to various embodiments, in operation 1816, the electronic device 101 may transmit the first signal and the second signal for UL-MIMO to the selected or configured first antenna and second antenna.

According to various embodiments, in operation 1806, when the identified RRC configuration message includes a configuration corresponding to PC1.5, the electronic device 101 may branch to A to perform the operations of FIG. 18B. For example, when the identified RRC configuration message includes a configuration corresponding to PC1.5 in operation 1806, the electronic device 101 may transmit the same data through the communication processor (e.g., the communication processor 260), in operation 1820, as illustrated in FIG. 18B. According to various embodiments, in operation 1822, the electronic device 101 may transmit the same data through the respective connected PAs through the first transmission chain and the second transmission chain.

According to various embodiments, the electronic device 101 may identify a change in the form of the electronic device, in operation 1824. For example, the electronic device 101 may identify that the form of the electronic device is changed from the open state to the closed state, or from the closed state to the open state.

According to various embodiments, when the flag of the device status index is identified as 0, in operation 1826, the electronic device 101 may configure an antenna considering antenna gain and isolation, in operation 1828. According to various embodiments, when the flag of the device status index is identified as 1 in operation 1826, the electronic device 101 may select or configure antennas to transmit the first signal and the second signal considering the EPA, in operation 1830.

According to various embodiments, when the antennas to transmit the first signal and the second signal are selected or configured in operation 1828 or 1830, the electronic device 101 may transmit the first signal and the second signal for PC1.5 to the selected or configured antennas, in operation 1832.

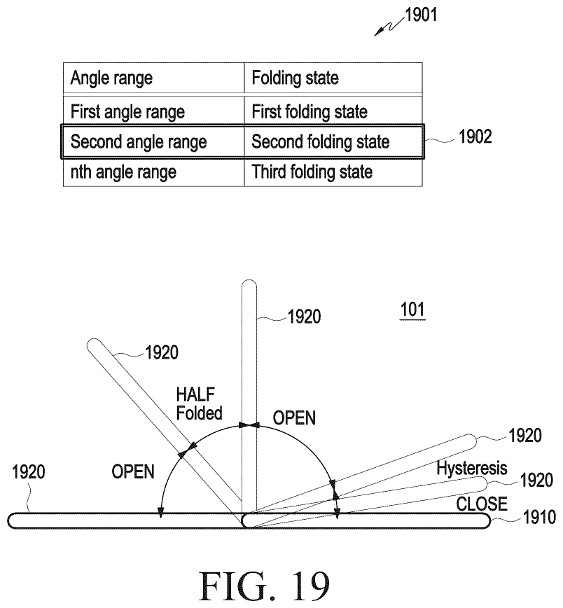

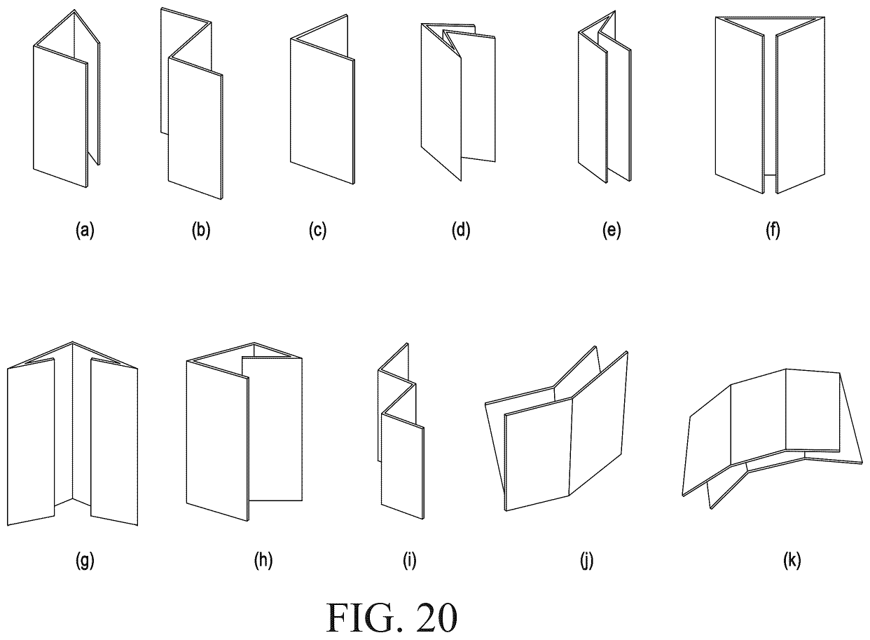

FIG. 19 is a view illustrating folding state information about an electronic device according to an embodiment of the disclosure.

FIG. 19 is a view illustrating a folding state of an electronic device 101 associated with an angle between housings (e.g., a first housing 1910 (e.g., the first housing 101a of FIG. 8)) and a second housing 1920 (e.g., the second housing 101b of FIG. 8)) of the electronic device according to various embodiments. According to various embodiments, the electronic device 101 (e.g., processor 120) may identify the state (e.g., the angle between the first housing 1910 and the second housing 1920) of the housings (e.g., the first housing 1910 and the second housing 1920) and generate a device status index (DSI) corresponding to the identified folding state. For example, the electronic device may identify the angle between the first housing 1910 and the second housing 1920 and, as illustrated in FIG. 19, identify a second folding state 1902 corresponding to a second angle range including the identified angle among a plurality of folding states of folding state information 1901.

For example, the electronic device 101 (e.g., processor 120) may identify the folding state corresponding to the angle between the housings (e.g., the first housing 1910 and the second housing 1920). As illustrated in FIG. 19, the electronic device 101 may store a plurality of pieces of folding state information 1901 related to the angle between the first housing 1910 and the second housing 1920 in the memory 130 as the device status index. The device status index may be stored in the form of a state flag as described above. According to various embodiments, in the above-described embodiments, the state flag corresponding to the device status index is set to two states of 0 or 1, but as illustrated in FIG. 19, a state flag corresponding to three states or a state flag corresponding to 4 or more states may be set. According to various embodiments, the communication processor 260 may identify folding state information corresponding to the current angle between the first housing 1910 and the second housing 1920. Each of the plurality of pieces of folding state information 1901 (e.g., a first folding state, second folding state, and third folding state of FIG. 19) may correspond to a specific angle range (e.g., the first angle range, second angle range, and third angle range of FIG. 19).

According to various embodiments, without being limited thereto, the above description may apply even where more than two housings are provided. For example, when the electronic device 101 includes three housings (e.g., the first housing 1910 to third housing), folding state information corresponding to the first angle range between the first housing 1910 and the second housing 1920 and the second angle range between the second housing 1920 and the third housing may be determined. According to various embodiments, the electronic device 101 (e.g., processor 120) may identify the angle between the first housing 1910 and the second housing 1920 at various times. For example, when at least one of the first housing 1910 or the second housing 1920 starts to rotate (e.g., clockwise or counterclockwise), the electronic device 101 (e.g., processor 120) may identify the angle between the first housing 1910 and the second housing 1920. As an example, the electronic device 101 (e.g., processor 120) may continuously identify the angle between the first housing 1910 and the second housing 1920 while at least one of the first housing 1910 or the second housing 1920 starts to rotate and rotates about the rotation axis. As another example, at the time when at least one of the first housing 1910 or the second housing 1920 ends rotation about the rotation axis, the electronic device 101 may identify the angle between the first housing 1910 and the second housing 1920. As an example, the electronic device 101 (e.g., processor 120) may identify the angle between the first housing 1910 and the second housing 1920 at a designated period regardless of rotation of at least one of the first housing 1910 or the second housing 1920.

According to various embodiments, an input framework of the electronic device 101 may receive various sensing values for measuring the open/closed state of the electronic device 101. The input framework may identify sensing values obtained from at least one or more sensors, determine the open/closed state of the electronic device 101, and transfer the determined state to the processor 120. For example, the sensor driver (e.g., at least one or more of an angle sensor driver, a distance sensor driver, and a gyro sensor driver) may transfer the sensing value to the input framework. The input framework may transmit, to a folding event handler, information indicating that the electronic device 101 is in the second folding state using the obtained sensing value. The folding event handler may transfer an event of the processor 120 corresponding to the folding state information to the communication processor 260.

FIG. 20 is a view illustrating examples of a flexible display according to an embodiment of the disclosure.

According to various embodiments, an electronic device (e.g., the electronic device 101 of FIG. 1) may include two or more housing structures rotatably connected with each other and a flexible display. According to various embodiments, the flexible display may be disposed on two or more housing structures and may be bent according to the rotational state of the housing structures.

According to various embodiments, the electronic device may be formed in various forms according to two or more housing structures and a flexible display provided in the electronic device and a rotational state of the housing structures. For example, as illustrated in FIG. 20, the various forms include a form (half fold) in which two areas are formed in the electronic device (e.g., a flexible display), a form (e.g., tri fold, z fold, or single open gate fold) in which three areas are formed in the electronic device (e.g., a flexible display), a form (e.g., double parallel reverse fold, double parallel fold, double gate fold, roll fold, accordion fold, half fold then half fold) in which four areas are formed in the electronic device (e.g., a flexible display), and a fold (e.g., half fold then tri fold) in which more areas are formed. The electronic device may include housing structures rotatably connected with each other and a flexible display. The housing structures may be rotated into a corresponding form.

The electronic device and the operation method thereof according to various embodiments of the disclosure may also be applied not only to an electronic device including two housing structures but also to an electronic device including three or more housings and a flexible display as illustrated in FIG. 20.

The electronic device according to various embodiments of the disclosure may include at least one antenna in each of the at least two housing structures. As illustrated in FIG. 20, the radiation direction of the antenna included in each housing structure and the distance between the antennas may be changed as each housing structure is folded into an unfolded state or a folded state.

According to various embodiments, when an electronic device (e.g., a foldable electronic device, a rollable electronic device, or a slidable electronic device) having a transformable form factor supports dual Tx (2Tx), it may provide the optimized performance (e.g., TPUT or TRP) according to the state (open state or closed state) of the electronic device and the transmission mode (e.g., UL-MIMO or PC1.5).

According to various embodiments, as described above, when the electronic device operates in UL-MIMO, the TPUT performance may be optimized using an antenna having large isolation between the antennas. When the electronic device operates in PC1.5, it is rendered to perform EPA operation in the closed state, thereby maximizing the transmission performance of the electronic device. For example, when operating in UL-MIMO considering the current state of the electronic device having a transformable form factor or the state change, the TPUT performance may be maximally secured and, when operating in PC1.5, the TRP may be maximized, securing maximum coverage between the electronic device and the network. Accordingly, it is possible to increase the transmission/reception quality of the electronic device, reduce current consumption under the same conditions of the network and the electronic device, and accordingly reduce heat generation.

According to various embodiments, an electronic device may comprise a housing configured to be movable between a first state and a second state. The electronic device may comprise a first radio frequency (RF) circuit comprising a first amplifier. The electronic device may comprise a second RF circuit comprising a second amplifier. The electronic device may comprise memory storing instructions. The electronic device may comprise at least one processor. The instructions, when executed by the at least one processor, may cause the electronic device to identify a transmission mode currently set among a plurality of transmission modes. The instructions may cause the electronic device to, in a first transmission mode of the plurality of transmission modes, transmit first signals corresponding to first data through the first amplifier, and concurrently transmit second signals corresponding to second data through the second amplifier, wherein the first data is different from the second data. The instructions may cause the electronic device to, in a second transmission mode of the plurality of transmission modes, transmit the first signals through the first amplifier, and concurrently transmit the second signals through the second amplifier, wherein the first signals and the second signals correspond to same data. The instructions may cause the electronic device to identify a state of the housing among the first state and the second state. The instructions may cause the electronic device to, based on the transmission mode currently set and the state of the housing, identify a first antenna, selected from a plurality of antennas, for transmitting the first signals, and identify a second antenna, selected from the plurality of antennas, for transmitting the second signals. The instructions may cause the electronic device to transmit the first signals through the first amplifier and the first antenna, and concurrently transmit the second signals through the second amplifier and the second antenna.

According to an embodiment, the housing may include a foldable housing including a first housing portion and a second housing portion movable between a closed state and an open state. The first housing portion may include a plurality of first conductive portions forming an exterior side surface thereof, and the second housing portion may include a plurality of second conductive portions forming an exterior side surface thereof. The instructions may, when executed by the at least one processor, cause the electronic device to, in case that the transmission mode is the second transmission mode, and a form of the electronic device corresponds to the closed state of the foldable housing, identify one of the plurality of first conductive portions included in the first housing portion to be used as the first antenna for transmitting the first signals and identify one of the plurality of second conductive portions included in the second housing portion to be used as the second antenna for transmitting the second signals. The one of the plurality of first conductive portions included in the first housing used as the first antenna and the one of the plurality of second conductive portions included in the second housing used as the second antenna, for transmitting the first signals and the second signals in the second transmission mode may at least partially overlap each other in the closed state of the foldable housing.

According to an embodiment, the instructions may, when executed by the at least one processor, cause the electronic device to, based on identifying that the transmission mode currently set is the second transmission mode, and the form of the electronic device corresponds to the closed state of the foldable housing, form a feeding position of the first antenna and a feeding position of the second antenna so that a current direction of the first antenna is identical to a current direction of the second antenna.

According to an embodiment, the instructions may, when executed by the at least one processor, cause the electronic device to, based on identifying that the transmission mode currently set is the second transmission mode, and the form of the electronic device corresponds to the closed state of the foldable housing, identify the first antenna and the second antenna, which meet an equivalent phase antenna (EPA) condition.

According to an embodiment, the instructions may, when executed by the at least one processor, cause the electronic device to, based on identifying that the transmission mode currently set is the second transmission mode, and the form of the electronic device corresponds to the open state of the foldable housing, identify the first antenna and the second antenna, which maximize an efficiency of transmission diversity.

According to an embodiment, the instructions may, when executed by the at least one processor, cause the electronic device to: based on identifying that the transmission mode currently set is the first transmission mode, and the form of the electronic device corresponds to the open state or the closed state of the foldable housing, identify the first antenna and the second antenna, which maintain isolation from each other or maximize an antenna gain.

According to an embodiment, the first transmission mode may include an uplink-multi input multi output (UL-MIMO) mode.

According to an embodiment, the second transmission mode may include a power class 5 (PC1.5) mode.

According to an embodiment, the instructions may, when executed by the at least one processor, cause the electronic device to identify the transmission mode currently set based on a configuration message received through a communication network.

According to an embodiment, the configuration message may include a radio resource control (RRC) reconfiguration message.

According to various embodiments, a method for operating an electronic device including a housing configured to be movable between a first state and a second state, a first radio frequency (RF) circuit comprising a first amplifier, a second RF circuit comprising a second amplifier, and at least one processor may comprise identifying a transmission mode currently set among a plurality of transmission modes. The method for operating the electronic device may comprise, in a first transmission mode of the plurality of transmission modes, transmitting first signals corresponding to first data through the first amplifier, and concurrently transmitting second signals corresponding to second data through the second amplifier, wherein the first data is different from the second data. The method for operating the electronic device may comprise, in a second transmission mode of the plurality of transmission modes, transmitting the first signals through the first amplifier, and concurrently transmitting the second signals through the second amplifier, wherein the first signals and the second signals correspond to same data. The method for operating the electronic device may comprise identifying a state of the housing among the first state and the second state. The method for operating the electronic device may comprise, based on the transmission mode currently set and the state of the housing, identifying a first antenna, selected from a plurality of antennas, for transmitting the first signals, and identifying a second antenna, selected from the plurality of antennas, for transmitting the second signals. The method for operating the electronic device may comprise transmitting the first signals through the first amplifier and the first antenna, and concurrently transmitting the second signals through the second amplifier and the second antenna.

According to an embodiment, the housing may include a foldable housing including a first housing portion and a second housing portion movable between a closed state and an open state. The first housing portion may include a plurality of first conductive portions forming an exterior side surface thereof, and the second housing portion may include a plurality of second conductive portions forming an exterior side surface thereof. The method may comprise, in case that the transmission mode is the second transmission mode, and the form of the electronic device corresponds to the closed state of the foldable housing, identifying one of the plurality of first conductive portions included in the first housing portion to be used as the first antenna for transmitting the first signals and identifying one of the plurality of second conductive portions included in the second housing portion to be used as the second antenna for transmitting the second signals. The one of the plurality of first conductive portions included in the first housing used as the first antenna and the one of the plurality of second conductive portions included in the second housing used as the second antenna, for transmitting the first signals and the second signals in the second transmission mode may at least partially overlap each other in the closed state of the foldable housing.

According to an embodiment, the method may comprise, based on identifying that the transmission mode currently set is the second transmission mode, and the form of the electronic device corresponds to the closed state of the foldable housing, forming a feeding position of the first antenna and a feeding position of the second antenna so that a current direction of the first antenna is identical to a current direction of the second antenna.

According to an embodiment, the method may comprise, based on identifying that the transmission mode currently set is the second transmission mode, and the form of the electronic device corresponds to the closed state of the foldable housing, identifying the first antenna and the second antenna, which meet an equivalent phase antenna (EPA) condition.

According to an embodiment, the method may comprise, based on identifying that the transmission mode currently set is the second transmission mode, and the form of the electronic device corresponds to the open state of the foldable housing, identifying the first antenna and the second antenna, which maximize an efficiency of transmission diversity.

According to an embodiment, the method may comprise, based on identifying that the transmission mode currently set is the first transmission mode, and the form of the electronic device corresponds to the open state or the closed state of the foldable housing, identifying the first antenna and the second antenna, which maintain isolation from each other or maximize an antenna gain.

According to an embodiment, the first transmission mode may include an uplink-multi input multi output (UL-MIMO) mode.

According to an embodiment, the second transmission mode may include a power class 5 (PC1.5) mode.

According to an embodiment, the method may comprise identifying the transmission mode currently set based on the configuration message received through a communication network.

According to an embodiment, the configuration message may include a radio resource control (RRC) reconfiguration message.

According to various embodiments, in a storage medium storing at least one computer-readable instruction, the at least one instruction may, when executed by at least one processor of an electronic device including a housing configured to be movable between a first state and a second state, a first radio frequency (RF) circuit comprising a first amplifier, a second RF circuit comprising a second amplifier, and the at least one processor, cause the electronic device to perform at least one operation. The at least one operation may comprise identifying a transmission mode set among a plurality of transmission modes. The at least one operation may comprise, in a first transmission mode of the plurality of transmission modes, transmitting first signals corresponding to first data through the first amplifier, and concurrently transmitting second signals corresponding to second data through the second amplifier, wherein the first data is different from the second data. The at least one operation may comprise, in a second transmission mode of the plurality of transmission modes, transmitting the first signals through the first amplifier, and concurrently transmitting the second signals through the second amplifier, wherein the first signals and the second signals correspond to same data. The at least one operation may comprise identifying a state of the housing among the first state and the second state. The at least one operation may comprise, based on the transmission mode currently set and the state of the housing, identifying a first antenna, selected from a plurality of antennas, for transmitting the first signals, and identifying a second antenna, selected from the plurality of antennas, for transmitting the second signals. The at least one operation may comprise transmitting the first signals through the first amplifier and the first antenna, and concurrently transmit the second signals through the second amplifier and the second antenna.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing configured to be movable between a first state and a second state;
a first radio frequency (RF) circuit comprising a first amplifier;
a second RF circuit comprising a second amplifier;
memory storing one or more computer programs; and
one or more processors communicatively coupled to the first RF circuit, the second RF circuit, and the memory,
wherein the one or more computer programs include computer-executable instructions that, when executed by the one or more processors individually or collectively, cause the electronic device to:
identify a transmission mode currently set among a plurality of transmission modes,
in a first transmission mode of the plurality of transmission modes, transmit first signals corresponding to first data through the first amplifier, and concurrently transmit second signals corresponding to second data through the second amplifier, wherein the first data is different from the second data,
in a second transmission mode of the plurality of transmission modes, transmit the first signals through the first amplifier, and concurrently transmit the second signals through the second amplifier, wherein the first signals and the second signals correspond to same data,
identify a state of the housing among the first state and the second state,
based on the transmission mode currently set and the state of the housing, identify a first antenna, selected from a plurality of antennas, for transmitting the first signals, and identify a second antenna, selected from the plurality of antennas, for transmitting the second signals, and
transmit the first signals through the first amplifier and the first antenna, and concurrently transmit the second signals through the second amplifier and the second antenna.

2. The electronic device of claim 1,
wherein the housing comprises a foldable housing including a first housing portion and a second housing portion movable between a closed state and an open state,
wherein the first housing portion includes a plurality of first conductive portions forming an exterior side surface thereof, and the second housing portion includes a plurality of second conductive portions forming an exterior side surface thereof,
wherein the one or more computer programs further include computer-executable instructions that, when executed by the one or more processors individually or collectively, cause the electronic device to:
in case that the transmission mode currently set is the second transmission mode, and a form of the electronic device corresponds to the closed state of the foldable housing, identify one of the plurality of first conductive portions included in the first housing portion to be used as the first antenna for transmitting the first signals and identify one of the plurality of second conductive portions included in the second housing portion to be used as the second antenna for transmitting the second signals, and
wherein the one of the plurality of first conductive portions included in the first housing used as the first antenna and the one of the plurality of second conductive portions included in the second housing used as the second antenna, for transmitting the first signals and the second signals in the second transmission mode, at least partially overlap each other in the closed state of the foldable housing.

3. The electronic device of claim 2, wherein the one or more computer programs further include computer-executable instructions that, when executed by the one or more processors individually or collectively, cause the electronic device to:
based on identifying that the transmission mode currently set is the second transmission mode and the form of the electronic device corresponds to the closed state of the foldable housing, form a feeding position of the first antenna and a feeding position of the second antenna so that a current direction of the first antenna is identical to a current direction of the second antenna.

4. The electronic device of claim 2, wherein the one or more computer programs further include computer-executable instructions that, when executed by the one or more processors individually or collectively, cause the electronic device to:
based on identifying that the transmission mode currently set is the second transmission mode and the form of the electronic device corresponds to the closed state of the foldable housing, identify the first antenna and the second antenna, which meet an equivalent phase antenna (EPA) condition.

5. The electronic device of claim 2, wherein the one or more computer programs further include computer-executable instructions that, when executed by the one or more processors individually or collectively, cause the electronic device to:
based on identifying that the transmission mode currently set is the second transmission mode and the form of the electronic device corresponds to the open state of the foldable housing, identify the first antenna and the second antenna, which maximize an efficiency of transmission diversity.

6. The electronic device of claim 2, wherein the one or more computer programs further include computer-executable instructions that, when executed by the one or more processors individually or collectively, cause the electronic device to:
based on identifying that the transmission mode currently set is the first transmission mode and the form of the electronic device corresponds to the open state or the closed state of the foldable housing, identify the first antenna and the second antenna, which maintain isolation from each other or maximize an antenna gain.

7. The electronic device of claim 1, wherein the first transmission mode comprises an uplink-multi input multi output (UL-MIMO) mode.

8. The electronic device of claim 7, wherein the second transmission mode

9. The electronic device of claim 1, wherein the one or more computer programs further include computer-executable instructions that, when executed by the one or more processors individually or collectively, cause the electronic device to:
identify the transmission mode currently set based on a configuration message received through a communication network.

10. The electronic device of claim 9, wherein the configuration message comprises a radio resource control (RRC) reconfiguration message.

11. A method performed by an electronic device including a housing configured to be movable between a first state and a second state, a first radio frequency (RF) circuit comprising a first amplifier, a second RF circuit comprising a second amplifier, and one or more processors communicatively coupled to the first RF circuit, and the second RF circuit, the method comprising:
identifying, by the electronic device, a transmission mode currently set among a plurality of transmission modes;
in a first transmission mode of the plurality of transmission modes, transmitting, by the electronic device, first signals corresponding to first data through the first amplifier, and concurrently transmitting, by the electronic device, second signals corresponding to second data through the second amplifier, wherein the first data is different from the second data;
in a second transmission mode of the plurality of transmission modes, transmitting, by the electronic device, the first signals through the first amplifier, and concurrently transmitting, by the electronic device, the second signals through the second amplifier, wherein the first signals and the second signals correspond to same data;
identifying, by the electronic device, a state of the housing among the first state and the second state;
based on the transmission mode currently set and the state of the housing, identifying, by the electronic device, a first antenna, selected from a plurality of antennas, for transmitting the first signals, and identifying, by the electronic device, a second antenna, selected from the plurality of antennas, for transmitting the second signals; and
transmitting, by the electronic device, the first signals through the first amplifier and the first antenna, and concurrently transmitting, by the electronic device, the second signals through the second amplifier and the second antenna.

12. The method of claim 11,
wherein the housing comprises a foldable housing including a first housing portion and a second housing portion movable between a closed state and an open state,
wherein the first housing portion includes a plurality of first conductive portions forming an exterior side surface thereof, and the second housing portion includes a plurality of second conductive portions forming an exterior side surface thereof,
wherein the method further comprises:
based on identifying that the transmission mode currently set is the second transmission mode, and identifying that a form of the electronic device corresponds to the closed state of the foldable housing, identifying, by the electronic device, one of the plurality of first conductive portions included in the first housing portion to be used as the first antenna for transmitting the first signals and identifying, by the electronic device, one of the plurality of second conductive portions included in the second housing portion to be used as the second antenna for transmitting the second signals, and
wherein the one of the plurality of first conductive portions included in the first housing used as the first antenna and the one of the plurality of second conductive portions included in the second housing used as the second antenna, for transmitting the first signals and the second signals in the second transmission mode, at least partially overlap each other in the closed state of the foldable housing.

13. The method of claim 12, further comprising
based on identifying that the transmission mode currently set is the second transmission mode and the form of the electronic device corresponds to the closed state of the foldable housing, forming, by the electronic device, a feeding position of the first antenna and a feeding position of the second antenna so that a current direction of the first antenna is identical to a current direction of the second antenna.

14. The method of claim 12, further comprising
based on identifying that the transmission mode currently set is the second transmission mode and the form of the electronic device corresponds to the closed state of the foldable housing, identifying, by the electronic device, the first antenna and the second antenna, which meet an equivalent phase antenna (EPA) condition.

15. The method of claim 12, further comprising:
based on identifying that the transmission mode currently set is the second transmission mode and the form of the electronic device corresponds to the open state of the foldable housing, identifying, by the electronic device, the first antenna and the second antenna, which maximize an efficiency of transmission diversity.

16. The method of claim 12, further comprising:
based on identifying that the transmission mode currently set is the first transmission mode and the form of the electronic device corresponds to the open state or the closed state of the foldable housing, identifying, by the electronic device, the first antenna and the second antenna, which maintain isolation from each other or maximize an antenna gain.

17. The method of claim 11, wherein the first transmission mode comprises an uplink-multi input multi output (UL-MIMO) mode.

18. The method of claim 11, wherein the second transmission mode comprises a power class 1.5 (PC1.5) mode.

19. The method of claim 11, further comprising:
identifying, by the electronic device, the transmission mode currently set based on a configuration message received through a communication network.

20. One or more non-transitory computer-readable storage media storing one or more computer programs including computer-executable instructions that, when executed by one or more processors of an electronic device individually or collectively, the electronic device including a housing configured to be movable between a first state and a second state, a first radio frequency (RF) circuit comprising a first amplifier, a second RF circuit comprising a second amplifier, and the one or more processors, cause the electronic device to perform operations, the operations comprising:
identifying, by the electronic device, a transmission mode currently set among a plurality of transmission modes;
in a first transmission mode of the plurality of transmission modes, transmitting, by the electronic device, first signals corresponding to first data through the first amplifier, and concurrently transmitting, by the electronic device, second signals corresponding to second data through the second amplifier, wherein the first data is different from the second data;
in a second transmission mode of the plurality of transmission modes, transmitting, by the electronic device, the first signals through the first amplifier, and concurrently transmitting, by the electronic device, the second signals through the second amplifier, wherein the first signals and the second signals correspond to same data;
identifying, by the electronic device, a state of the housing among the first state and the second state; based on the transmission mode currently set and the state of the housing, identifying, by the electronic device, a first antenna, selected from a plurality of antennas, for transmitting the first signals, and identifying, by the electronic device, a second antenna, selected from the plurality of antennas, for transmitting the second signals; and
transmitting, by the electronic device, the first signals through the first amplifier and the first antenna, and concurrently transmitting, by the electronic device, the second signals through the second amplifier and the second antenna.
